(19) United States
(12) Patent Application Publication
(10) Pub. No.: US 2002/0018173 A1
(43) Pub. Date: Feb. 14, 2002

(54) Method for producing liquid crystal display elements

(76) Inventors: Keiichi Furukawa, Suita-shi (JP); Jun Yamada, Takatasuki-Shi (JP); Kiyofumi Hashimoto, Suita-Shi (JP)

Correspondence Address: SIDLEY AUSTIN BROWN & WOOD, 717 NORTH HARWOOD, SUITE 3400, DALLAS, TX, 75201, US

(21) Appl. No.: 09/898,734

(22) Filed: Jul. 3, 2001

(30) Foreign Application Priority Data
Jul. 6, 2000 (JP) 2000-205697

(51) Int. Cl. G02F 1/13

(52) U.S. Cl. 349/187

(57) ABSTRACT

A method of producing a plurality of liquid crystal display elements, each of the elements including first and second substrates, a liquid crystal and a seal wall, each of the substrates being provided with electrodes, the seal wall being arranged between the substrates, surrounding the liquid crystal and being adhered to both of the substrates, the method comprising the steps of: (a) producing a display elements group through first and second steps, the first step being performed to form the seal walls for the plurality of the liquid crystal display elements on at least one of first and second sheets, the second step being performed to adhere the sheets together with the seal walls therebetween, and to expose first and second terminal portions of each of the plurality of the liquid crystal display elements by removing at least one predetermined removal portion from at least one of the sheets; and (b) dividing the display elements group into the plurality of the liquid crystal display elements or into the plurality of empty-liquid crystal display elements for the plurality of the liquid crystal display elements, by cutting at least one of the sheets of the display elements group in at least one predetermined position, the dividing step being performed after the display elements group producing step.

### CROSS-REFERENCE TO RELATED APPLICATION

This invention is based on Japanese patent application No. 2000-205697 filed in Japan on Jul. 6, 2000, the entire content of which is hereby incorporated by reference.

### BACKGROUND OF THE INVENTION

1. Field of the Invention

The present invention relates to a method for producing a plurality of liquid crystal display elements each comprising a liquid crystal and a seal wall between a pair of first and second substrates having electrodes, the seal wall surrounding the liquid crystal and adhering to the substrates, and more particularly to a method for producing a plurality of liquid crystal display elements from a pair of sheets (substrates) on a multi-piece production basis.

This invention also concerns with a method for producing a plurality of vacant liquid crystal display elements (so-called empty cells) each having a seal wall between a first substrate and a second substrate each having electrodes, the seal wall adhering to the two substrates for sealing a liquid crystal.

2. Description of Related Art

In a liquid crystal display element, a liquid crystal is provided between a pair of substrates so that the orientation of liquid crystal molecules is altered by applying a voltage across the electrodes formed on the substrates to thereby display images. Usually a seal wall for preventing a leakage of liquid crystal, as well as the liquid crystal, is arranged between a pair of substrates. The seal wall adheres to each of the two substrates and surrounds the liquid crystal between the two substrates.

For example, liquid crystal display elements are produced as follows. A pair of first and second substrates are provided and then electrodes and the like are formed on respective substrates. Then a seal wall is formed from an adhesive material (sealing material) on at least one of the two substrates. Thereafter the first and second substrates are fixed together via the seal wall therebetween. If a liquid crystal is supplied onto the substrate before fixing the substrates, a liquid crystal display element is obtained by fixing the substrates via the liquid crystal and the seal wall therebetween. Optionally a liquid crystal display element may be produced by injecting a liquid crystal into a space surrounded with the substrates and the seal wall after fixing the substrates.

To increase the productivity, a plurality of liquid crystal display elements may be produced from a pair of first and second sheets (substrates). In this case, a plurality of seal walls are formed on the sheet before fixing the sheets. Then the first and second sheets are fixed with the plural seal walls therebetween. Subsequently the first and second sheets are cut along predetermined cut lines to give plural liquid crystal display elements. Liquid crystals are placed into the spaces between the substrates in the same manner as done in producing a single liquid crystal display element. This type of method is termed a multi-piece production method. After division into plural liquid crystal display elements, usually a specified portion is removed from each sheet to expose the electrodes on the sheet. A drive element for driving the liquid crystal display element is mounted, for example, on a sheet portion having the exposed electrodes to connect the drive element to the electrodes.

### SUMMARY OF THE INVENTION

An object of this invention is to provide a method for producing a plurality of liquid crystal display elements on a multi-piece production basis, the method being capable of producing liquid crystal display elements with less labor and in less time than conventional methods.

Another object of the invention is to provide a method for producing a plurality of vacant liquid crystal display elements on a multi-piece production basis, the method being capable of producing vacant liquid crystal display elements with less labor and in less time than conventional methods.

The invention provides a method of producing a plurality of liquid crystal display elements, each of the liquid crystal display elements including a first substrate, a second substrate, a liquid crystal and a seal wall, the first substrate being provided with a plurality of first electrodes formed thereon, the second substrate being provided with a plurality of second electrodes formed thereon, the liquid crystal being arranged between the first and second substrates, the seal wall being arranged between the first and second substrates, surrounding the liquid crystal and being adhered to both of the first and second substrates, the method comprising:

(a) a display elements group producing step of producing a display elements group through first and second steps,

the first step being performed to form the seal walls for the plurality of the liquid crystal display elements on at least one of first and second sheets,

the first sheet being provided with the first electrodes for the plurality of the liquid crystal display elements, and including a plurality of portions that are to be the first substrates for the plurality of the liquid crystal display elements,

the second sheet being provided with the second electrodes for the plurality of the liquid crystal display elements, and including a plurality of portions that are to be the second substrates for the plurality of the liquid crystal display elements,

the second step being performed to adhere the first and second sheets together with the seal walls therebetween, and to expose first and second terminal portions of each of the plurality of the liquid crystal display elements by removing at least one predetermined removal portion from at least one of the first and second sheets; and

(b) a dividing step of dividing the display elements group into the plurality of the liquid crystal display elements or into the plurality of empty-liquid crystal display elements for the plurality of the liquid crystal display elements, by cutting at least one of the first and second sheets of the display elements group in at least one predetermined position, the dividing step being performed after the display elements group producing step.

The foregoing and other objects, features, aspects and advantages of the present invention will become more apparent from the following detailed description and the accompanying drawings.

### BRIEF DESCRIPTION OF THE DRAWINGS

FIG. 1 is a schematic section view showing an example of the liquid crystal display element to be produced by the producing method of this invention.

FIG. 2 is a schematic perspective view of the liquid crystal display element of FIG. 1.

FIG. 3(A) shows the liquid crystal display element of FIG. 1 to which substrates having drive ICs mounted thereon is connected. FIG. 3(B) shows the liquid crystal display element of FIG. 1 in which drive ICs are mounted directly on the paired substrates.

FIGS. 4(A) and 4(B) are views showing an example of arrangement of seal walls formed of an adhesive material supplied onto at least one of the paired substrates.

FIG. 5 is a view showing an example of the method of fixing the two substrates.

FIGS. 6(A) and 6(B) show the states of an example of an assembly of liquid crystal display elements before and after the electrode-exposing step. FIG. 6(C) shows a liquid crystal display element produced by dividing the assembly of liquid crystal display elements.

FIGS. 7(A) and 7(B) show the states of another example of the assembly of liquid crystal display elements before and after the electrode-exposing step. FIG. 7(C) shows liquid crystal display elements which can be produced by dividing the assembly of liquid crystal display elements.

FIG. 8(A) is a schematic plan view showing part of an assembly of liquid crystal display elements having dummy walls formed thereon. FIG. 8(B) is a schematic perspective view showing the assembly of liquid crystal display elements when a predetermined substrate portion is being peeled from the substrate.

FIG. 9 is a schematic plan view showing part of another example of the assembly of liquid crystal display elements after the electrode-exposing step.

FIG. 10(A) is a view showing the liquid crystal display elements on which an inspecting step is being conducted. FIG. 10(B) is an enlarged plan view of row electrodes and FIG. 10(C) is an enlarged plan view of column electrodes.

FIG. 11 is a view showing another example of the method of fixing the two substrates.

FIG. 12 is a view showing a further example of the method of fixing the two substrates.

FIGS. 13(A) and 13(B) are views showing other examples of seal walls formed of an adhesive material supplied onto at least one of the paired substrates.

FIG. 14(A) shows an assembly of vacant liquid crystal display elements having a plurality of seal walls each having an inlet port for entry of liquid crystal in which the electrode-exposing step has been performed. FIG. 14(B) shows the assembly of vacant liquid crystal display elements after pre-division. FIG. 14(C) shows a liquid crystal display element produced by further division of the assembly of vacant liquid crystal display elements of FIG. 14(B).

### DESCRIPTION OF THE PREFERRED EMBODIMENTS

### §1. FIRST TYPE AND SECOND TYPE PRODUCING METHODS

In the following description, first type and second type producing methods are presented.

### §1.1. FIRST TYPE PRODUCING METHOD

The first type producing method for producing liquid crystal display elements can produce a plurality of liquid crystal display elements in which a liquid crystal and a seal wall surrounding the liquid crystal are interposed between a first substrate and a second substrate each having electrodes, and the seal wall adheres to the first and second substrates. The method comprises the steps of:

supplying an adhesive material in a predetermined configuration onto at least one of two substrates (at least one of first and second sheets) to form a plurality of seal walls (adhesive material-supplying step);

supplying liquid crystal onto at least one of the substrates (at least one of the first and second sheets) (liquid crystal-supplying step);

fixing the first and second substrates (first and second sheets) via the liquid crystal and the seal walls between the substrates (fixing step);

dividing the first and second substrates (first and second sheets) by cutting them along predetermined cut lines after the fixing step to give a plurality of liquid crystal display elements (dividing step); and

removing specified substrate portions from the second and first substrates (second and first sheets) to expose the electrodes on the first and second substrates (first and second sheets) of each liquid crystal display element after conducting the fixing step (electrode-exposing step),

wherein the electrode-exposing step is carried out before the dividing step.

### §1.2. SECOND TYPE PRODUCING METHOD

The second type producing method for producing liquid crystal display elements can produce a plurality of liquid crystal display elements in which a liquid crystal and a seal wall surrounding the liquid crystal are interposed between a first substrate and a second substrate each having electrodes, and the seal wall adheres to the first and second substrates. The method comprises the steps of:

supplying an adhesive material in a predetermined configuration onto at least one of the two substrates (at least one of the first and second sheets) to form a plurality of seal walls (adhesive material-supplying step);

fixing the first and second substrates (first and second sheets) via the seal walls between the substrates (fixing step);

dividing the first and second substrates (first and second sheets) by cutting them along predetermined cut lines after the fixing step to give a plurality of liquid crystal display elements or a plurality of vacant liquid crystal display elements (dividing step);

injecting a liquid crystal into spaces each surrounded with the two substrates (sheets) and the seal wall after the fixing step (liquid crystal-injecting step); and

removing specified substrate portions from the first and second substrates (first and second sheets) to expose the electrodes on the first and second substrates (first and second sheets) of each liquid crystal display element after the fixing step (electrode-exposing step),

wherein the electrode-exposing step is carried out before the dividing step.

### §1.3.

The liquid crystal display elements produced by any of the first type and second type producing methods have a pair of first and second substrates, and a liquid crystal and a seal wall held between the two substrates. Electrodes are formed on the first and second substrates. The liquid crystal is provided between the two substrates. The seal wall serves to seal the liquid crystal. The seal wall is arranged between the two substrates and surrounds the liquid crystal. The seal wall is adhered to both the first and second substrates and is formed of an adhesive material (sealing material). The liquid crystal is arranged in the space surrounded with the pair of substrates and the seal wall. The seal wall serves to prevent a leakage of the liquid crystal from the space between the substrates.

The liquid crystal display elements produced by any of the first type and second type producing methods may have spacers, resin structures and the like. The spacers are arranged between the substrates to control the predetermined gap (thickness of liquid crystal) therebetween. The resin structures can be used to control the gap between the substrates. The resin structures are provided between the substrates and adhere to at least one of the substrates. The resin structures adhering to the two substrates can increase the connection of the two substrates and can suppress peel of the seal wall from the substrate(s).

According to any of the first type and second type producing methods, a plurality of liquid crystal display elements are produced at one time using the first and second substrates (sheets) as described in detail later. In the description given hereinafter, the first and second substrates having a size required for producing a plurality of liquid crystal display elements are referred to as the first and second sheets, respectively. The first sheet includes first substrates corresponding to a plurality of liquid crystal display elements to be produced, and similarly the second sheet includes second substrates corresponding to a plurality of liquid crystal display elements to be produced.

In any of the first type and second type producing methods, a plurality of liquid crystal display elements are produced on a multi-piece production basis from a pair of sheets. Stated more specifically, a plurality of seal walls are formed from the adhesive material on the sheet(s) before fixing the first and second sheets. Then after the first and second sheets are fixed with the seal walls formed of the adhesive material therebetween, the sheets are divided into plural portions to give a plurality of liquid crystal display elements.

In the first type producing method, a liquid crystal is disposed in spaces each surrounded with the sheets and the seal wall by being supplied onto the sheet(s) before and/or during fixing the sheets as described in detail later.

In the second type producing method, a liquid crystal is disposed in spaces each surrounded with the sheets and the seal wall by being injected into the spaces after fixing the sheets. The second type producing method gives, first, vacant liquid crystal display elements in which a liquid crystal is not disposed in the space surrounded with the sheets (substrates) and the seal wall.

A marked difference between the first type and second type producing methods lies in whether the liquid crystal is present on the sheet(s) when the sheets are fixed. In the first type producing method, the liquid crystal is supplied onto the sheet(s) before and/or during fixing the sheets, so that the first and second sheets are fixed with the liquid crystal and the seal walls therebetween. In the second type producing method, the liquid crystal is injected into the spaces each surrounded with the sheets (substrates) and the seal wall after fixing the sheets, so that the first and second sheets are fixed with the seal walls therebetween but without a liquid crystal therebetween. Substantially all of steps in the first type and second type producing methods are similar to each other. What is described below is true with respect to any of the first type and second type producing methods unless specifically stated.

Both first type and second type producing methods include the adhesive material-supplying step, fixing step, dividing step, and electrode-exposing step. The first type producing method further includes the liquid crystal-supplying step. The second type producing method further includes a liquid crystal-injecting step.

Of course, all of materials required for production such as sheets are provided before conducting each step.

As stated above, a spacer-supplying step is conducted when supplying spacers between the substrates (sheets). A resin structure-forming step is conducted when forming resin structures between the substrates (sheets). The steps are described below. The order of describing the steps is not necessarily the order of the steps of producing liquid crystal display elements. The timing for conducting each step is stated in the elucidation of steps.

(a) Preliminary Step

In producing liquid crystal display elements by the first type or second type producing method, at least a pair of first and second sheets (substrates), a liquid crystal and an adhesive material (sealing material) for forming seal walls are required.

The pair of sheets (substrates) thus provided are those having a size corresponding to a plurality of liquid crystal display elements to be produced.

At least one of the first and second sheets (at least one of the first and second substrates in a liquid crystal display element) may be, for example, a flexible sheet (substrate). The flexible sheet (substrate) may be, for example, a film formed of a polymer. Examples of useful materials for the polymer sheet (substrate) are polyether sulfone (PES), polycarbonate (PC), polyethylene terephthalate (PET), polyarylate (PA), polyether ether ketone (PEEK), cyclic amorphous polyolefin, etc. The thickness of the polymer sheet (substrate) is, for example, about 50 μm to about 1000 μm. The use of a thin sheet (substrate) can reduce the thickness of the liquid crystal display element as a whole, and can lessen the weight thereof.

Electrodes are formed on respective sheets (substrates) to display images by altering the orientation of liquid crystal molecules. For simple matrix drive of liquid crystal display element, each sheet (substrate) may be provided with a plurality of strip electrodes. For active matrix drive of liquid crystal display element, TFT, MIM or like active elements as well as electrodes may be formed on the sheet (substrate). The liquid crystal display elements produced by the first type or second type producing method can be any of elements capable of achieving light-transmitting type display or light reflection-type display.

When required, an orientation film, an insulating film, a gas barrier film and the like may be formed on the sheet (substrate).

The liquid crystal (liquid crystal composition) to be arranged between the substrates of the liquid crystal display element may be a liquid crystal composition containing a liquid crystal exhibiting a cholesteric phase (e.g. a liquid crystal exhibiting a cholesteric phase at room temperature). The liquid crystal exhibiting a cholesteric phase selectively reflects the light of wavelength corresponding to the helical pitch of liquid crystal. Accordingly the crystal liquid display element in which a liquid crystal exhibiting a cholesteric phase is arranged between the substrates can be used as a liquid crystal display element of the reflection type. The liquid crystal exhibiting a cholesteric phase may contain a dye for adjustment of a display color.

Useful liquid crystals exhibiting a cholesteric phase include, for example, a cholesteric liquid crystal exhibiting a cholesteric phase by itself, and a chiral nematic liquid crystal containing a nematic liquid crystal and a chiral material added thereto. The chiral nematic liquid crystal has advantages that with the amount of the chiral material used, the helical pitch can be adjusted and the selective reflection wavelength can be easily adjusted.

(b) Adhesive Material-Supplying Step

In the adhesive material-supplying step, the adhesive material is supplied in a predetermined configuration onto at least one of the sheets. The adhesive material-supplying step is conducted before the sheet-fixing step.

Using the adhesive material supplied onto the sheet, a plurality of seal walls are formed. The seal walls formed of the adhesive material are adhered to each of the first and second substrates (sheets) after fixing the sheets.

Dummy walls having a function to be described later as well as the seal walls may be formed from the adhesive material supplied to the sheet(s). The dummy walls formed of the adhesive material like the seal walls are adhered to each of the first and second sheets after fixing the sheets. However, dummy walls do not function as the seal walls for preventing a leakage of liquid crystal from the space between the substrates. A sheet portion (substrate portion) on which the dummy wall is formed may be eventually removed from the obtained liquid crystal display element.

In brief, at least a plurality of seal walls are formed from the adhesive material supplied to the sheet in the adhesive material-supplying step.

The adhesive material for seal walls may be selected, for example, from materials conventionally known as sealing materials. The adhesive material for seal walls may be the same kind as or a different kind from that of the adhesive material (sealing material) for dummy walls. If these two types of materials are the same kind, they can be supplied efficiently onto the sheet.

The adhesive material may be, for example, a UV-curing resin or a thermosetting resin.

The adhesive material may be supplied onto the sheet, for example, by a dispenser method, ink-jet method or the like. Optionally the adhesive material may be supplied thereonto by a printing method using a screen plate, metal mask or the like. Or the adhesive material can be supplied thereonto by a transfer method in which it is supplied onto a flat plate or a roller and transferred to the sheet therefrom.

Among a plurality of seal walls formed of the adhesive material (sealing material) on the sheet, all of them may be those of the same size, or one or more seal walls may differ in size from other seal walls. More specifically, the first type and second type producing methods give a plurality of liquid crystal display elements among which all of the elements may be those of the same size, or one or more elements may differ in size from other elements. When a plurality of liquid crystal display elements of the same size are produced, the plurality thereof in the same shape may be produced, or one or more thereof may be those differing from others in the direction of projection of electrodes. The direction of projection of electrodes refers to a direction in which a substrate portion used for connection of electrodes to the drive element extends from the substrate portion which overlaps the other substrate.

(c) Spacer-Supplying Step

The spacer-supplying step is carried out when spacers are supplied between the two substrates in a liquid crystal display element. This step is conducted when so required.

In the spacer-supplying step, spacers are supplied to at least one of the first and second sheets (substrates).

The spacers exist between the first and second substrates (sheets) after fixing the first and second sheets, and serve to control a gap (thickness of the liquid crystal) between the first and second substrates.

The spacers may be either fixable ones which can be fixed to the substrate or non-fixable ones which can not be fixed thereto.

The non-fixable spacers may be, for example, particles of hard materials which do not deform when heated or pressed. Examples of non-fixable spacers comprising particles of such hard materials are fine particles of glass fibers, spherical particles of silicic acid glass, alumina particles and like inorganic material particles, and spherical particles of divinylbenzene crosslinked polymers, polystyrene crosslinked polymers and like organic synthetic materials.

The fixable spacers may be, for example, non-fixable spacers coated with a hot-melt adhesive, thermosetting resins, UV-curing resins or the like.

The spacers can be supplied onto the sheet (substrate) by being dispersed on the sheet by the conventional method such as a dry method, wet method or the like. The spacers are dispersed, typically before the sheet-fixing step. For example, the spacers are dispersed over regions surrounded with seal walls after forming the seal walls on the sheet from an adhesive material. The spacers can be dispersed only on regions surrounded with the seal walls by using a mask.

The spacers may be supplied onto the sheet (substrate) simultaneously with a supply of a liquid crystal by being dispersed in the liquid crystal to be supplied onto the sheet in the liquid crystal-supplying step.

(d) Resin Structure-Forming Step

The resin structure-forming step is conducted when resin structures are disposed between the substrates in a liquid crystal display element. The resin structure-forming step is optionally carried out and is performed before the sheet-fixing step.

The resin structures are formed on at least one of first and second sheets in the resin structure-forming step.

The resin structures exist between the first and second substrates (first and second sheets) after the sheets are fixed together. The resin structures are adhered to at least one of the substrates (sheets). The resin structures can retain a gap between the two substrates at a constant distance. The resin structures adhering to the first and second substrates can increase the strength of the entire liquid crystal display element and can maintain the gap between the two substrates to keep the gap from widening.

Resin structures may be formed, for example, in a region inside of the seal wall on the substrate. Optionally resin structures may be formed in regions both inside and outside of the seal wall. The resin structures can be formed, for example, by a printing method in which a paste of resin-containing material (e.g. a resin dissolved in a solvent) is forced out onto a sheet through a screen plate, a metal mask or the like using a squeegee. The resin structures can be formed by forcing out a resin from one end of a nozzle onto the sheet by a dispenser method, ink-jet method or the like. The resin structures can be formed as well by a transfer method in which a resin is supplied onto a flat plate or a roller and is transferred to the sheet therefrom.

Materials for resin structures include, for example, those which can be softened by heating and can be solidified by cooling. Useful materials for resin structures include organic substances of suitable flexibility which do not undergo a chemical reaction with a liquid crystal to be used. Such materials for resin structures include, for example, thermoplastic polymer materials. Examples of such thermoplastic polymer materials are polyvinyl chloride resins, polyvinylidene chloride resins, polyvinyl acetate resins, polymethacrylic acid ester resins, polyacrylic acid ester resins, polystyrene resins, polyamide resins, polyethylene resins, polypropylene resins, fluorine-containing resins, polyurethane resins, polyacrylonitrile resins, polyvinyl ether resins, polvinyl ketone resins, polyether resins, polyvinyl pyrrolidone resins, saturated polyester resins, polycarbonate resins, chlorinated polyether resins, etc. Resin structures can be formed of a material containing one or more of these resins.

The shape of the resin structure can be any of dot-like shapes including columns which are, e.g., circular, square or elliptic in section.

(e) Liquid Crystal-Supplying Step

The liquid crystal-supplying step is conducted in the first type producing method.

The liquid crystal-supplying step is conducted before and/or during the sheet fixing step. The liquid crystal is supplied onto at least one of first and second sheets in the liquid crystal-supplying step.

The liquid crystal can be supplied onto the sheet, for example, dropwise and may be supplied onto the entire surface or one or more portions of the sheet (one or more portions of the substrate in the liquid crystal display element). For example, after a plurality of seal walls are formed on the sheet from an adhesive material, the liquid crystal may be supplied to regions surrounded with the seal walls. The supply of liquid crystal in this way is conducted, for example, before fixing the sheets.

The liquid crystal may be supplied to the space between the sheets before and/or during the fixing step, when the first and second sheets are fixed progressively from one end of the sheets to the other end thereof in the sheet-fixing step. When the liquid crystal is supplied during the fixing step, the liquid crystal need not be continuously supplied during the fixing step, but may be supplied only for at least part of the fixing period. For example, the liquid crystal may be supplied from the beginning of fixing operation to an intermediate point thereof (e.g. intermediately before completion thereof).

(f) Fixing Step (Sheet-Fixing Step)

In the fixing step of the first type producing method, the first and second sheets are fixed together with the adhesive material (the seal walls formed of the adhesive material) and the liquid crystal between the sheets.

In the fixing step of the second type producing method, the first and second sheets are fixed together with the seal walls therebetween. In the second type producing method, the first and second sheets are fixed together without a liquid crystal interposed between the two sheets.

In any case, the adhesive material is adhered to each of the first and second sheets in the fixing step, whereby the sheets are fixed together. The first and second sheets are joined together such that a plurality of seal walls formed from the adhesive material are arranged between the first and second sheets.

In the fixing step, the first and second sheets may be joined together, for example, by pressing the sheets successively from one end of the sheets to the other end thereof.

The first and second sheets may be joined together by applying heat as well as a pressure. For example, the first and second sheets may be joined together by applying heat as well as a pressure to the sheets successively from one end of the sheets to the other end thereof.

When at least one of the first and second sheets is flexible, one of the flexible sheets may be joined as bent progressively to the other sheet in the fixing step. When a liquid crystal is supplied onto the sheet before fixing the sheets, the first and second sheets are preferably superimposed over each other progressively from one end of the sheets to the other end thereof in order to assure an escape of air bubbles, instead of superimposing the two sheets over each other in their entirety at one time. By bending the flexible sheet, the first and second sheets can be superimposed on each other in this way progressively from one end of the sheets to the other end thereof. A pressure may be applied successively to the portions of first and second sheets being progressively superimposed on each other, whereby the first and second sheets can be joined together while discharging the air bubbles from between the first and second sheets. This suppresses remaining of air bubbles in the liquid crystal, resulting in production of a liquid crystal display element capable of achieving better image display. When only one of the first and second sheets is flexible, the flexible sheet may be successively fixed as bent to the other sheet. When both of the first and second sheets are flexible, at least one of the flexible sheets may be successively fixed as bent to the other sheet.

When at least one of the first and second sheets is flexible, the sheets are successively fixed to each other while, for example, pressing the sheets as stated below in the items (f1) and (f2). If the flexible sheet is the second sheet, the first sheet may be either flexible or inflexible.

(f1) For example, the first sheet is supported in a flat state by a support member, and the second sheet which is flexible is superimposed as bent at one end over the first sheet supported by the support member with the adhesive material between them. One or more pressing members are moved relatively to the first sheet supported by the support member. Thereby the second sheet is pressed against the first sheet progressively from one end of the sheets to the other end thereof, whereby the first and second sheets are fixed together.

The pressing member may be, for example, a pressing roller and a plurality of pressing members may be used.

In fixing the sheets, the pressing member may be moved relatively to the support member. The pressing member or the support member may be moved, or both may be moved.

When the first and second sheets are fixed together in this way, a liquid crystal is supplied onto at least one of the sheets, e.g. before fixing the sheets as described above.

When the sheets are fixed while being pressed and heated, for example, a heating member may be moved relatively to the first sheet supported by the support member, so that the sheets are fixed together while being heated from the second sheet side, successively from one end of the sheets to the other end thereof.

The heating member may be, for example, one having a heater on its surface or in its interior. For example, the heating member may be a heating roller internally provided with a heater. A plurality of heating members may be used. The heating member may be operated in contact or out of contact with the second sheet. When using a heating member operable in contact with the second sheet, a higher heating efficiency is achieved. The heating member may serve also as a pressing member. That is, heat and pressure may be applied by a pressing-heating member (e.g. pressing-heating roller) for pressing and heating the sheets. When the sheets are fixed while being pressed by a plurality of pressing members as described above, at least one of pressing members may be used as a pressing-heating member capable of heating as well as pressing the sheets.

When the sheets are fixed while being heated, they may be heated from the side of the support member supporting the first sheet. In this case, a heater for heating the support member may be provided. Of course, the sheets may be fixed while being heated from both the first sheet side and the second sheet side.

(f2) The first and second sheets are passed between a pair of first and second pressing members opposed to each other while they are successively superimposed over each other via the adhesive material therebetween, whereby the sheets are fixed together.

The pressing member may be, for example, a pressing roller, a pressing belt or the like.

For example, the first and second sheets are successively passed as superimposed over each other through a nip between the first and second pressing members to fix the first and second sheets. When the sheets are passed between the pressing members, of course, the pressing members may be moved relatively to the sheets, or the sheets may be moved relatively to the pressing members, or both the sheets and the pressing members may be moved.

The sheets may be successively fixed while being pressed by plural pairs of pressing members (pairs of first and second pressing members).

When the sheets are fixed while being pressed and heated by a pair of pressing members, e.g. at least one of the paired pressing members may be employed to serve also as a heating member. In this case, the first and second sheets may be successively fixed while being pressed and heated from one end of the sheets to the other end thereof by the pair of pressing members including the pressing-heating member serving also as a heating member. When the sheets are fixed while being pressed by a plurality of pressing members as described above, at least one of the paired pressing members may be employed to serve also as a heating member.

When at least a pair of pressing rollers are used as the paired pressing members, the first and second sheets may be passed through the pair of pressing rollers from an upper side in a direction vertical to a horizontal direction (which is the axis direction of the pressing rollers) to a lower side, whereby the sheets can be fixed together.

When the first and second sheets are fixed by being passed between at least a pair of pressing members in this way, a liquid crystal may be supplied onto the sheet(s) while the sheets are fixed progressively from one end of the sheets to the other end thereof as stated above.

(g) After the sheets are fixed together in the fixing step according to the first type producing method, the following assembly of liquid crystal display elements, namely a group of liquid crystal display elements, is provided.

After the sheets are fixed together in the fixing step according to the second type producing method, the following assembly of vacant liquid crystal display elements (empty cells), namely a group of vacant liquid crystal display elements, is provided.

The assembly of liquid crystal display elements and the assembly of vacant liquid crystal display elements each have the first and second sheets. The electrodes are formed on each of sheets. A plurality of seal walls are formed between the first and second sheets. The seal walls are adhered to both the first and second sheets. A plurality of spaces surrounded with seal walls are formed between the first and second sheets.

The assembly of liquid crystal display elements has liquid crystals filled in spaces surrounded with the two sheets (substrates) and seal walls. The assembly of vacant liquid crystal display elements has no liquid crystal filled in the spaces surrounded with the two sheets (substrates) and seal walls.

Each liquid crystal display element in the assembly thereof at this stage is a structurally substantially finished product although incomplete in that the liquid crystal display elements are connected to each other and that the electrodes are not exposed on the substrate portions for connection to a drive element.

Each vacant liquid crystal display element in the assembly thereof at this stage is a structurally substantially finished product although incomplete in that the vacant liquid crystal display elements are connected to each other; that the electrodes are not exposed on the substrate portions for connection to a drive element; and that no liquid crystal is filled in each space surrounded with the seal wall.

(h) Liquid Crystal-Injecting Step

In the second type producing method, the liquid crystal-injecting step is conducted after the fixing step.

The liquid crystal-injecting step may be executed before or after the electrode-exposing step to be described later. The liquid crystal-injecting step may be executed before or after the dividing step to be described later. In any case, the liquid crystal-injecting step may be executed after the fixing step.

In the liquid crystal-injecting step, a liquid crystal is injected into the spaces.

In the liquid crystal-injecting step, a liquid crystal is injected into spaces each surrounded with the first and second substrates and the seal wall. In order to inject a liquid crystal into the space, for example, an inlet port for entry of liquid crystal may be formed in each seal wall formed of an adhesive material in the adhesive material-supplying step. The liquid crystal may be injected into the space surrounded with the substrates and the seal wall, for example, by vacuum injection method. After injection of liquid crystal, the inlet port for entry of liquid crystal is closed with a sealing material.

(i) Electrode-Exposing Step

The electrode-exposing step is carried out after the fixing step.

The electrode-exposing step is carried out before the dividing step to be described later.

In the first type producing method, the electrode-exposing step is carried out on a plurality of liquid crystal display elements connected to each other.

In the second type producing method, the electrode-exposing step is conducted on a plurality of liquid crystal display elements connected together or a plurality of vacant liquid crystal display elements connected together. Stated more specifically, when the liquid crystal-injecting step is carried out before the electrode-exposing step in the second type producing method, the electrode-exposing step is performed on a plurality of liquid crystal display elements connected to each other. When the liquid crystal-injecting step is not carried out before the electrode-exposing step in the second type producing method, the electrode-exposing step is performed on a plurality of vacant liquid display elements connected to each other.

In the electrode-exposing step, each predetermined substrate portion is removed from the first and second substrates (each predetermined sheet portion is removed from the first and second sheets) in the assembly of liquid crystal display elements (or the assembly of vacant liquid crystal display elements) in order to expose the electrodes on the first and second substrates of each liquid crystal display element in the assembly of liquid crystal display elements (or in order to expose the electrodes on the first and second substrates of each vacant liquid crystal display elements in the assembly of vacant liquid crystal display elements). Even if the electrode-exposing step is carried out on the assembly of vacant liquid crystal display elements, the electrode-exposing step is carried out after all to expose the electrodes on the first and second substrates of each liquid crystal display element.

The predetermined substrate portion is removed from the second substrate to expose the electrodes on the first substrate of each liquid crystal display element (or each vacant liquid crystal display element). The predetermined portion is removed from the first substrate to expose the electrodes on the second substrate of each liquid crystal display element (or each vacant liquid crystal display element).

The first substrate portion and the second substrate portion, in which the electrodes of each liquid crystal display element (each vacant liquid crystal display element) are exposed, are located on the outside of the seal wall.

The first substrate portion and the second substrate portion, in which the electrodes of each liquid crystal display element (each vacant liquid crystal display element) are exposed, are used for connecting the electrodes on each substrate to a drive element (e.g. drive IC). The drive element is a component of a driving device for driving the liquid crystal display element.

The drive element may be directly mounted, for example, on the first substrate portion exposing the electrodes to connect the electrodes to the drive element. Optionally a substrate having the drive element mounted thereon may be connected to the first substrate portion exposing the electrodes to connect the electrodes to the drive element. The substrate having the drive element mounted thereon may be in the so-called TCP (tape carrier package) form.

Similarly, the drive element may be directly mounted, for example, on the second substrate portion exposing the electrodes, or a substrate having the drive element mounted thereon may be connected to the second substrate portion exposing the electrodes to connect the electrodes to the drive element.

(j) Dividing Step

The dividing step is carried out after the sheet-fixing step and after the electrode-exposing step as described above.

In the dividing step of the first type producing method, the first and second sheets for the assembly of liquid crystal display elements are cut along the predetermined cut lines to divide them into a plurality of liquid crystal display elements, giving individual liquid crystal display elements unconnected to each other. More specifically, the dividing operation provides individual liquid crystal display elements in the same number as the seal walls formed on the sheet in the adhesive material-supplying step.

In the dividing step of the second type producing method, the first and second sheets for the assembly of liquid crystal display elements (or the assembly of vacant liquid crystal display elements) are cut along the predetermined cut lines to divide them into a plurality of liquid crystal display elements (or vacant liquid crystal display elements). That is, the first and second sheets are cut along the predetermined cut lines to divide them into a plurality of liquid crystal display element portions (liquid crystal display elements or vacant liquid crystal display elements) in the dividing step of the second type producing method. Stated more specifically, when the liquid crystal-injecting step is conducted before the dividing step in the second type producing method, the first and second sheets for the assembly of liquid crystal display elements are cut along the predetermined cut lines in the dividing step to divide them into a plurality of liquid crystal display elements. On the other hand, when the liquid crystal-injecting step is not conducted before the dividing step in the second type producing method, the first and second sheets for the assembly of vacant liquid crystal display elements are cut along the predetermined cut lines in the dividing step to divide them into a plurality of vacant liquid crystal display elements. In any case, the dividing step gives individual liquid crystal display elements (or individual vacant liquid crystal display elements) unconnected to each other. More specifically, the dividing operation provides individual liquid crystal display elements (or individual vacant liquid crystal display elements) in the same number as the seal walls formed on the sheet in the adhesive material-supplying step.

Each liquid crystal display element (or each vacant liquid crystal display element) thus obtained by the division has a pair of first and second substrates. Electrodes are formed on the respective substrates. A seal wall is formed between the first and second substrates and adheres to each of the first and second substrates. A space surrounded with the seal wall is formed between the first and second substrates.

In each liquid crystal display element, a liquid crystal is filled in the space surrounded with the two substrates and the seal wall. In each vacant liquid crystal display element, a liquid crystal is not filled in the space surrounded with the two substrates and the seal wall.

In any case, the electrode-exposing step is conducted before the dividing step so that the electrodes on each substrate is exposed in a region outside of the seal wall.

### §1.4.

In the above-described first type and second type producing methods, the following advantages are given since the dividing step is conducted after the electrode-exposing step.

Even when the electrode-exposing step is conducted after the dividing step unlike the above-described first type and second type producing methods, a plurality of liquid crystal display elements (vacant liquid crystal display elements) having exposed electrodes can be produced from a pair of sheets as done by the above-described producing methods.

That is to say, a plurality of liquid crystal display elements (or vacant liquid crystal display elements) having exposed electrodes can be produced also by the following method. An assembly of liquid crystal display elements (or an assembly of vacant liquid crystal display elements) is produced in the same manner as by the first type and second type producing methods; the assembly is divided into a plurality of liquid crystal display elements (or vacant liquid crystal display elements); and the electrode-exposing step is conducted on each liquid crystal display element (vacant liquid crystal display element). However, this method entails much more labor and time in conducting the electrode-exposing step, one by one, on each liquid crystal display element (or each vacant liquid crystal display element).

On the other hand, in the first type and second type producing methods, the electrode-exposing step is conducted on plural liquid crystal display elements (plural vacant liquid crystal display elements) connected to each other. Namely the electrode-exposing step is carried out in less time and with less labor than when this step is conducted on each liquid crystal display element (each vacant liquid crystal display element) in a state where it is individually held and transported. If the seal walls are formed as described later in the adhesive material-supplying step, the predetermined substrate portion can be removed from the substrate in much less time and with much less labor in the electrode-exposing step.

When a plurality of liquid crystal display elements are produced from a pair of sheets by the first type or second type producing method, one or more liquid crystal display elements may be different in the size from other display elements, or all of display elements may have the same size. If the paired sheets of the same size are used in any of the above cases, this means that the assemblies of liquid crystal display elements (or vacant liquid crystal display elements) on which the electrode-exposing step is conducted have the same size. Consequently there is no need in this case for exchanging a jig such as holding jig and the like and for considering different arrangements of operations. On the other hand, if the electrode-exposing step is carried out after the dividing step on liquid crystal display elements of different sizes, it would be necessary to use various holding jigs corresponding to each size. Namely, only a fewer holding jigs are required for producing liquid crystal display elements according to the first type and second type producing methods.

### §2.

Further description is given below to the first type and second type producing methods.

(a) Adhesive Material-Supplying Step

The seal walls may be formed in the following way in the adhesive material-supplying step to conduct the electrode-exposing step in less time and with less labor.

For example, the seal walls may be formed in the adhesive material-supplying step such that first substrate portions (first sheet portions) to be removed in the electrode-exposing step are arranged in a continuous form for at least two liquid crystal display elements (or vacant liquid crystal display elements) arranged in a predetermined first direction. If the first substrate portions (first sheet portions) to be removed in the electrode-exposing step are arranged in a continuous form for at least two liquid crystal display elements (or vacant liquid crystal display elements), the first substrate portions (first sheet portions) can be removed with less labor.

When the seal walls are formed such that at least two groups, each composed of at least two liquid crystal display elements (or vacant liquid crystal display elements) arranged in the first direction, are arranged in a third direction vertical (perpendicular) to the first direction, the seal walls may be formed such that first substrate portions (first sheet portions) for each group to be removed in the electrode-exposing step are arranged in a continuous form, and the seal walls may be also formed such that first substrate portions (first sheet portions) for at least two groups arranged in the third direction to be removed in the electrode-exposing step are arranged in a continuous form. In this way, the first substrate portions (first sheet portions) can be removed with less labor.

The seal walls may be formed in the adhesive material-supplying step such that second substrate portions (second sheet portions) to be removed in the electrode-exposing step are arranged in a continuous form for at least two liquid crystal display elements (vacant liquid crystal display elements) arranged in a predetermined second direction. If second substrate portions (second sheet portions) to be removed in the electrode-exposing step are arranged in a continuous form for at least two liquid crystal display elements (or vacant liquid crystal display elements), the second substrate portions (second sheet portions) can be removed with less labor. The second direction may be, for example, a direction vertical (perpendicular) to the first direction.

When the seal walls are formed such that at least two groups, each formed of at least two liquid crystal display elements (or vacant liquid crystal display elements) arranged in the second direction, are arranged in a fourth direction vertical (perpendicular) to the second direction, the seal walls may be formed such that second substrate portions (second sheet portions) for each group to be removed in the electrode-exposing step are arranged in a continuous form, and the seal walls may be also formed such that second substrate portions (second sheet portions) for at least two groups arranged in the fourth direction to be removed in the electrode-exposing step are arranged in a continuous form. In this way, the second substrate portions (second sheet portions) can be removed with less labor.

The sheet portions (substrate portions) to be removed on any one of the first sheet and the second sheet (the first substrate and the second substrate) alone may be arranged in a continuous form as described above, or those on both sheets may be so arranged.

(b) Electrode-Exposing Step

In the electrode-exposing step, the predetermined portions of the first and second sheets may be removed by peeling.

To facilitate removal (peeling) of the predetermined portions of the first and second sheets, at least one of the sheets may be notched (half-cut) along a boundary between the portion to be removed and the remaining portion of the sheet. The notching processing may be conducted whenever the processing can be easily done. For example, the processing can be performed before or after the fixing step. The processing may be performed before the adhesive-material supplying step.

(c) Adhesive Material-Supplying Step

Dummy wall(s) may be formed on at least one of the sheets in the adhesive material-supplying step as described below in addition to the seal walls to suppress separation of the seal walls adhering to the sheet from the sheet when the predetermined portion(s) is (are) removed (especially peeled off) from the sheet in the electrode-exposing step.

The dummy wall(s) can be formed on the sheet by supplying the adhesive material in the specified configuration onto at least one of the sheets. The dummy wall remains adhering to both of the first and second sheets after the fixing step. The dummy wall does not function as a seal wall serving to prevent a leakage of liquid crystal.

The dummy wall may be formed on the sheet along a boundary between the sheet portion to be removed and the remaining sheet portion, at least at an end portion on a side of initiating the removal of the sheet portion to be removed. When the dummy wall(s) is (are) formed from an adhesive material as described above, the predetermined sheet portion can be removed from the first or second sheet without giving a marked load or stress to the seal wall(s) in removing (especially peeling off) the predetermined portion from the first or second sheet. Accordingly the separation of seal walls from the sheet can be suppressed.

The dummy walls may be formed on a sheet portion which is not included in any liquid crystal display element (or any vacant liquid crystal display element) after the assembly of liquid crystal display elements (or the assembly of vacant liquid crystal display elements) is divided into plural liquid crystal display elements (or plural vacant liquid crystal elements) in the dividing step. That is, the dummy walls may be formed such that no dummy wall is left in any liquid crystal display element.

(d) Resin Structure-Forming Step

When resin structures are arranged between the substrates in a liquid crystal display element, the resin structures may be formed on the substrate in a region outside of the seal wall as well as a region inside thereof as described above.

In the case where the resin structures are formed in a region outside of the seal wall as well and are adhered to both of the first and second substrates, the sheets can be fixed together in the fixing step while these structures are more likely to suppress the deviation of position relation between the first and second substrates and loosening of substrates than when the resin structures are formed only in a region inside of the seal wall.

In the case where the resin structures are formed in a region outside of the seal walls as well as regions inside thereof and are adhered to both of the first and second sheets (first and second substrates), the resin structures need not be formed at an end portion of the sheet portion to be removed in the electrode-exposing step at which end portion the removal is initiated. The sheet portion to be removed in the electrode-exposing step is located in a region outside of the seal walls as stated above. In other words, resin structures may be formed in the region outside of the seal walls (other area than at an end portion of the sheet portion to be removed at which end portion the removal is initiated) as well as regions inside thereof. It would be easier to remove the sheet portion if resin structures adhering to both of the sheets are absent at the end portion of the sheet portion to be removed at which end portion the removal is initiated (when the removal is effected by peeling, peeling is initiated). In this case, the electrode-exposing step can be so easily done.

In the case where the resin structures formed in the region outside of the seal wall on the substrate of a liquid crystal display element interfere when a drive element is mounted on the substrate or a substrate having a drive element mounted thereon is mounted on the substrate, the resin structures may be removed before it is mounted thereon. Optionally resin structures may not be formed in the region outside of the seal wall on which a drive element is mounted.

(e) Liquid Crystal-Injecting Step

The liquid crystal-injecting step in the second type producing method may be conducted as described above before or after the dividing step.

When the liquid crystal-injecting step is conducted on a plurality of vacant liquid crystal display elements connected to each other before the dividing step, a liquid crystal can be injected into the plurality of vacant liquid crystal display elements collectively so that labor can be saved. In this case, the liquid crystal can be injected with less labor and in less time than when the liquid crystal is injected into individual vacant liquid crystal display elements obtained by the division.

Further, less labor is entailed in holding and transporting the display elements.

When a plurality of seal walls are formed, for example, in a line in the adhesive material-supplying step, and inlet ports for entry of liquid crystal are formed in a line on the seal walls, the liquid crystal can be easily injected into a plurality of vacant liquid crystal display elements arranged in continuous form. Optionally for example, the liquid crystal can be injected into each vacant liquid crystal display element by immersing in the liquid crystal only a portion surrounding the inlet port for entry of liquid crystal instead of immersing substantially the entire vacant liquid crystal display element thereinto. When two or more seal walls are arranged in a line in the adhesive material-supplying step, and the seal walls are arranged in a plurality of such lines, it may be difficult to conduct the liquid crystal-injecting step before the dividing step on vacant liquid crystal display elements in a continuous form in the same number as the seal walls formed in the adhesive material-supplying step. In such case, the following pre-dividing step may be conducted before the dividing step.

The pre-dividing step is conducted after the fixing step and before the dividing step. In the pre-dividing step, the assembly of vacant liquid crystal display elements is divided into plural small assemblies each including the liquid crystal display element(s) (in a number less than the seal walls formed in the adhesive material-supplying step) by cutting the first and second sheets in the predetermined cut lines. At least one vacant liquid crystal display element is left in each of the small assemblies, and the assembly of (all) vacant liquid crystal display elements is divided such that at least one assembly of plural (not all) vacant liquid crystal display elements is left by the division.

When at least two seal walls are formed in a line as described above in the adhesive material-supplying step and the seal walls are arranged in a plurality of such lines, the pre-dividing step may be carried out to give a plurality of assemblies of vacant liquid crystal display elements in which, for example, a plurality of seal walls are aligned in a line. If this pre-dividing step is done and if the inlet ports for entry of liquid crystal are formed in the adhesive material-supplying step such that the inlet ports formed in each seal wall are arranged in a line, the liquid crystal can be easily injected into a plurality of vacant liquid crystal display elements. In this case, after the liquid crystal-injecting step, each assembly of liquid crystal display elements is divided into liquid crystal display elements in the same number as the seal walls formed in the adhesive material-supplying step.

(f) Cleaning Step

In any of first type and second type producing methods, the following cleaning step may be conducted.

In the cleaning step, the liquid crystal on the outside of the seal wall is removed by cleaning. In the cleaning step, for example, the liquid crystal adhering to the first and second substrates outside of the seal wall and to the seal wall itself is removed by cleaning. When the liquid crystal-supplying step is conducted, the liquid crystal may be adhered to the substrates outside of the seal wall in the fixing step. When the liquid crystal-injecting step is conducted, the liquid crystal may be adhered to the substrates outside of the seal wall as by immersion of the inlet port for entry of liquid crystal in the liquid crystal. The cleaning step is conducted to remove the unwanted liquid crystal adhering to the liquid crystal display element portion excepting the space surrounded with the substrates and the seal wall where the liquid crystal is charged.

In the first type producing method, the cleaning step is conducted after the liquid crystal-supplying step. In the second type producing method, the cleaning step is conducted after the liquid crystal-injecting step. In any case, the cleaning step is performed after the fixing step.

The cleaning step may be effected before or after the dividing step. In the case where the cleaning step is conducted before the dividing step in the second type producing method, of course, the liquid crystal-injecting step is carried out before the cleaning step.

When the cleaning step is executed before the dividing step, the cleaning step can be performed with less labor than when the cleaning step is done on each liquid crystal display element obtained by the division.

In the cleaning step, for example, the assembly of liquid crystal display elements or each liquid crystal display element obtained by division may be immersed in a cleaning liquid to remove the unwanted liquid crystal by ultrasonic cleaning.

The cleaning step may be carried out before or after the electrode-exposing step. The cleaning step may be conducted, for example, after the electrode-exposing step and before the dividing step. When the electrode-exposing step is carried out before the cleaning step, the most of the liquid crystal to be removed is exposed, whereby it can be easily removed by cleaning.

(g) Inspecting Step

In any of first type and second type producing methods, each liquid crystal display element may be inspected for examination.

The inspecting step may be effected, for example, before the dividing step. For example, the inspecting step is performed after the electrode-exposing step and before the dividing step.

In the inspecting step, each liquid crystal display element may be checked for the conducting state of the electrodes formed on each substrate, breaking of the electrodes, a short circuit between the electrodes, and the position of short circuit.

When the electrodes are checked before the dividing step, the electrodes of plural liquid crystal display elements in the assembly thereof can be inspected collectively although depending on the pattern form of the electrodes. In this case, the time for inspecting the electrodes can be shortened compared with checking the individual display elements after the dividing step.

### §3. METHOD FOR PRODUCING VACANT LIQUID CRYSTAL DISPLAY ELEMENTS

Description is given below to a method for producing a plurality of vacant liquid crystal display elements (empty cells) each having a seal wall between a first substrate and a second substrate both provided with electrodes, the seal wall adhering to the two substrates for sealing a liquid crystal.

The method for producing a plurality of vacant liquid crystal display elements comprises the steps of:

supplying an adhesive material in a predetermined configuration onto at least one of the two substrates (at least one of the first and second sheets) to form a plurality of seal walls (adhesive material-supplying step);

fixing the first and second substrates (first and second sheets) with the seal walls between the substrates (fixing step);

dividing the first and second substrates (first and second sheets) by cutting them along predetermined cut lines after the fixing step to give a plurality of vacant liquid crystal display elements (dividing step); and

removing predetermined substrate portions from the first and second substrates (first and second sheets) after the fixing step in order to expose the electrodes on these substrates of each liquid crystal display element (electrode-exposing step),

wherein the electrode-exposing step is conducted before the dividing step.

The foregoing method for producing a plurality of vacant liquid crystal display elements is similar to the second type producing method in the case where the liquid crystal-injecting step is conducted after the dividing step, but is different from the latter in that the liquid crystal-injecting step is not conducted. In other words, when liquid crystal display elements are produced by conducting the liquid crystal-injecting step on the vacant liquid crystal display elements produced by the foregoing method, this means that the display elements are produced by the second type producing method.

In the foregoing method for producing vacant liquid crystal display elements, the electrode-exposing step is performed before the dividing step, so that the electrode-exposing step can be effected in less time and with less labor. The processings which can be done in injecting a liquid crystal after the dividing step as described above concerning the second type producing method can be used in the method for producing vacant liquid crystal display elements. The same effects can be obtained.

### §4. THIRD TYPE PRODUCING METHOD

In the following description, a third type of liquid crystal display elements producing method is presented.

According to the third type producing method, similar to the foregoing first and second types of the producing method, a plurality of liquid crystal display elements are produced.

Each of the liquid crystal display elements to be produced by the third type producing method is as follows.

Each of the liquid crystal display elements has a first substrate, a second substrate, a liquid crystal and a seal wall.

The first substrate is provided with a plurality of first electrodes formed thereon. Likewise, the second substrate is provided with a plurality of second electrodes formed thereon. The liquid crystal is arranged between the first and second substrates. The seal wall is arranged between the first and second substrates, surrounds the liquid crystal and is adhered to both of the first and second substrates.

The number of the liquid crystal display elements to be produced by the third type producing method, the number of the first electrodes formed on the first substrates of each of the liquid crystal display elements and the number of the second electrodes formed on the second substrates of each of the liquid crystal display elements may be different, or may be same. For example, the number of the first electrodes formed on the first substrate of the certain liquid crystal display element and the number of the second electrodes formed on the second substrate of the same liquid crystal display element may be same.

The plurality of liquid crystal display elements to be produced by the third type producing method may have same size and/or configuration, or may be different size and/or configuration. The number of the first electrodes of the certain liquid crystal display element and the number of the first electrodes of the other liquid crystal display element may be same or different. Likewise, the number of the second electrodes of the certain liquid crystal display element and the number of the second electrodes of the other liquid crystal display element may be same or different.

Each of the liquid crystal display elements to be produced by the third type producing method has a first terminal portion and a second terminal portion. In the first terminal portion (first electrode terminal portion), the plurality of first electrodes formed on the first substrate are exposed without being hidden by the second substrate. Likewise, in the second terminal portion (second electrode terminal portion), the plurality of second electrodes formed on the second substrate are exposed without being hidden by the first substrate. The first terminal portion may be typically utilized for connecting the plurality of first electrodes on the first substrate to one or more of driver element(s). Likewise, the second terminal portion may be typically utilized for connecting the plurality of second electrodes on the second substrate to one or more of driver element(s).

The third type producing method includes a display elements group producing step and a dividing step. The dividing step is performed after the display elements group producing step.

In the display elements group producing step, a display elements group (a group of display elements) is produced through following first and second steps.

In the first step, the seal walls for the plurality of liquid crystal display elements are formed on at least one of first and second sheets, which will be described later. One or more but not total (all) seal walls for the plurality of liquid crystal display elements to be produced may be formed on the first sheet, and the remaining seal wall(s) may be formed on the second sheet. The number of the seal walls formed in the first step may be typically same as the number of the liquid crystal display elements to be produced by the third type producing method.

The first sheet, used in the first step, has a size which is required for producing the plurality of liquid crystal display elements by the third type producing method, and includes a plurality of portions that are to be the first substrates for the plurality of liquid crystal display elements to be produced by the third type producing method.

The first sheet, used in the first step, is provided with the first electrodes for the plurality of liquid crystal display elements to be produced by the third type producing method. These first electrodes may be formed before performing the first step, that is, before forming the seal walls. The number of the first electrodes formed on the first sheet depends on, e.g., an arrangement relationship between the seal walls and the first electrodes. The number of the first electrodes on the first sheets may be (P×Q) in some cases, may be Q in other cases, or may be a particular number depending on P and/or Q in other cases, assuming that the number of the liquid crystal display elements to be produced by the third type producing method is P (P is a natural number and is equal to or larger than 2), and the number of the first electrodes formed on each of the first substrates of each of the liquid crystal display elements to be produced by the third type of producing method is Q (Q is a natural number and is equal to or larger than 2). For example, in the case where the seal walls of P in number are formed, e.g., to be arranged along a perpendicular direction with respect to the extending direction of each of the first electrodes, the number of the first electrodes may be (P×Q). In the case where the seal walls of P in number are formed, e.g., to be arranged along the extending direction of each of the first electrodes, the number of the first electrodes may be Q.

Likewise, the second sheet, used in the first step, has a size which is required for producing the plurality of liquid crystal display elements by the third type producing method, and includes a plurality of portions that are to be the second substrates for the plurality of the liquid crystal display elements to be produced by the third type producing method. These second electrodes may be formed before performing the first step, that is, before forming the seal walls. The number of the second electrodes formed on the second sheet depends on, e.g., an arrangement relationship between the seal walls and the second electrodes. The number of the second electrodes on the second sheets may be (P×R) in some cases, may be R in other cases, or may be a particular number depending on P and/or R in other cases, assuming that the number of the liquid crystal display elements to be produced by the third type producing method is P (P is a natural number and is equal to or larger than 2), and the number of the second electrodes formed on each of the second substrates of each of the liquid crystal display elements to be produced by the third type producing method is R (R is a natural number and is equal to or larger than 2).

The first and/or second sheet may be a sheet having a flexibility. The first and/or second sheet may be a polymer film. The first and/or second sheet may be further provided with an orientation film, insulating film, gas barrier film, or two or more of the films and/or other film(s), if necessary.

In the second step, the first and second sheets are fixed or adhered together with the seal walls formed in the first step therebetween. In the second step, the first and second sheets may be fixed together therebetween with the liquid crystals for the plurality the liquid crystal display elements to be produced by the third type producing method. The liquid crystal may be filled into each of the liquid crystal display elements (into each space surrounded by the seal walls) after performing the second step, that is, after fixing the first and second sheets together with the seal walls therebetween. More specifically, the liquid crystal may be filled into each of the liquid crystal display elements (into each of empty-liquid crystal display elements), after the second step and before the dividing step, or alternatively, after the second step and further after the dividing step.

In the second step, in addition to the operation of fixing of the first and second sheets, the first and second terminal portions of each of the plurality of liquid crystal display elements are exposed by removing at least one predetermined removal portion from at least one of the first and second sheets. The operation of removing at least one removal portion may be typically performed after the operation of the fixing of the first and second sheets. Each of the first and second sheets may have at least one removal portion, in which case at least one removal portion of each of the first and second sheets may be removed for exposing the first and second terminal portions of each of the liquid crystal display elements.

Through the above first and second steps, the display elements group is obtained. In the display elements group, the plurality of liquid crystal display elements are not separated apart but are in a continuous form, or alternatively, the plurality of empty-liquid crystal display elements are not separated apart but are in a continuous form. Further, the first and second terminal portions of each of the liquid crystal display elements or empty-liquid crystal display elements are exposed in the display elements group.

It can be considered that the display elements group has the similar structure to the foregoing liquid crystal display element assembly which is already subjected to the electrode exposing step in the first type of the producing step, or the foregoing empty-liquid crystal display element assembly which is already subjected to the electrode exposing step in the second type of the producing step.

In the dividing step after the display elements group producing step, at least one of the first and second sheets of the display elements group is cut in at least one predetermined position. At least one of the first and second sheets of the display elements group may be cut along at least one predetermined cutting line.

Thereby, the display elements group is divided into the plurality of liquid crystal display elements so that the plurality of liquid crystal display elements are obtained in the case where the first and second sheets are fixed together with the liquid crystals therebetween in the second step, or in the case where the liquid crystal is filled into each of the liquid crystal display elements (into each of the empty-liquid crystal elements) after the second step and before the dividing step.

In the case where the first and second sheets are fixed together without the liquid crystal therebetween in the second step, and the liquid crystal is not filled into each of the liquid crystal display elements (into each of the empty-liquid crystal elements) before the dividing step, the display elements group is divided into the plurality of empty-liquid crystal display elements so that the plurality of empty-liquid crystal display elements for the plurality of liquid crystal display elements are obtained. The number of the empty-liquid crystal display elements after dividing the display elements group may be same as the number of the liquid crystal display elements to be produced by the third type producing method. Each of the empty-liquid crystal display elements has similar structure to the liquid crystal display element except that the liquid crystal is not arranged between the first and second substrates in the empty-liquid crystal display element. In this case, the plurality of liquid crystal display elements can be obtained by filling the liquid crystal into each of the empty-liquid crystal display elements, e.g., after dividing the display elements group into the plurality of empty-liquid crystal display elements.

According to the third type producing method as described above, the first and second terminal portions of each liquid crystal display element can be exposed in less time and with less labor.

### §4.1.

Further description is given below to the third type producing method. The third type producing method may be carried out partly in the same manner as described concerning the first type and second type methods.

(a) In the third type producing method, the liquid crystal on the outside of the seal wall may be removed by cleaning after the display-element group producing step. The cleaning step may be conducted, for example, before the dividing step. The cleaning step in the third type producing method can be executed in the same manner as the cleaning step, for example, in the first type and second type producing methods.

(b) The first and second sheets can be fixed together as described below in the second step of the third type producing method.

For example, the first and second sheets may be fixed together in the same manner as done in fixing the two substrates (sheets) in the first type and second type producing methods. The first and second sheets may be adhered together, for example, while being heated and/or pressed.

(c) The plurality of seal walls may be formed, for example, as described below in the first step of the third type producing method.

For example, the plurality of seal walls may be formed in the same manner as the adhesive material-supplying step in the first type and second type methods.

For example, the plurality of seal walls may be formed in such arrangement that predetermined portion(s) to be removed from the first and/or second sheets can be easily removed. For example, the plurality of seal walls may be formed as arranged in a specified direction. The plurality of seal walls may be formed such that the predetermined portion(s) is (are) located between the seal walls adjacent to each other. The plurality of seal walls may be formed in such arrangement that the plural seal walls are arranged in a matrix form.

(d) In the first step of the third type producing method, one or more dummy walls in addition to seal walls may be formed as in the adhesive material-supplying step of the first type and second type producing methods. Dummy wall(s) may be adhered to both of first and second sheets in the second step.

Dummy wall(s) may be formed, for example, along the predetermined portion(s) to be removed. Optionally dummy wall(s) may be formed at an end portion of at least one of the first and second sheets. Dummy wall(s) may be formed in position(s) which is (are) not included in any liquid crystal display element after the dividing step.

(e) In the third type producing method, one or more resin structures may be formed on at least one of the first and second sheets before the second step. The resin structure-forming step in the third type producing method may be conducted in the same manner, for example, as the resin structure-forming step in the first type and second type producing methods.

In the resin structure-forming step, resin structures may be formed in region(s) outside and inside of the seal walls and resin structures may not be formed at a portion of the predetermined portion to be removed which exists on a side of initiating the removal.

(f) In the third type producing method, each liquid crystal display element in the display element group may be inspected before the dividing step. The inspecting step in the third type producing method may be conducted, for example, in the same manner as the inspecting step in the first type and second type producing methods.

(g) In the third type producing method, the pre-dividing step and spacer-supplying step may be conducted, respectively, in the same manner as in the first type and second type producing methods.

### §5.

Preferred embodiments of the invention are described below with reference to the accompanying drawings.

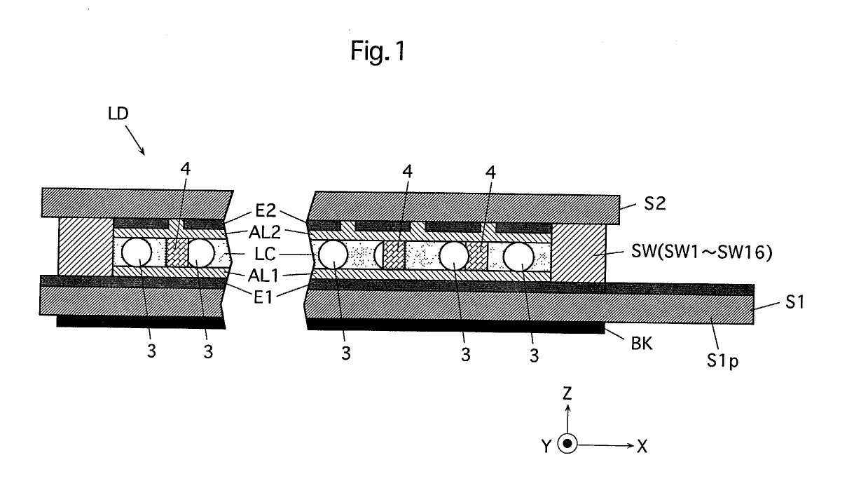

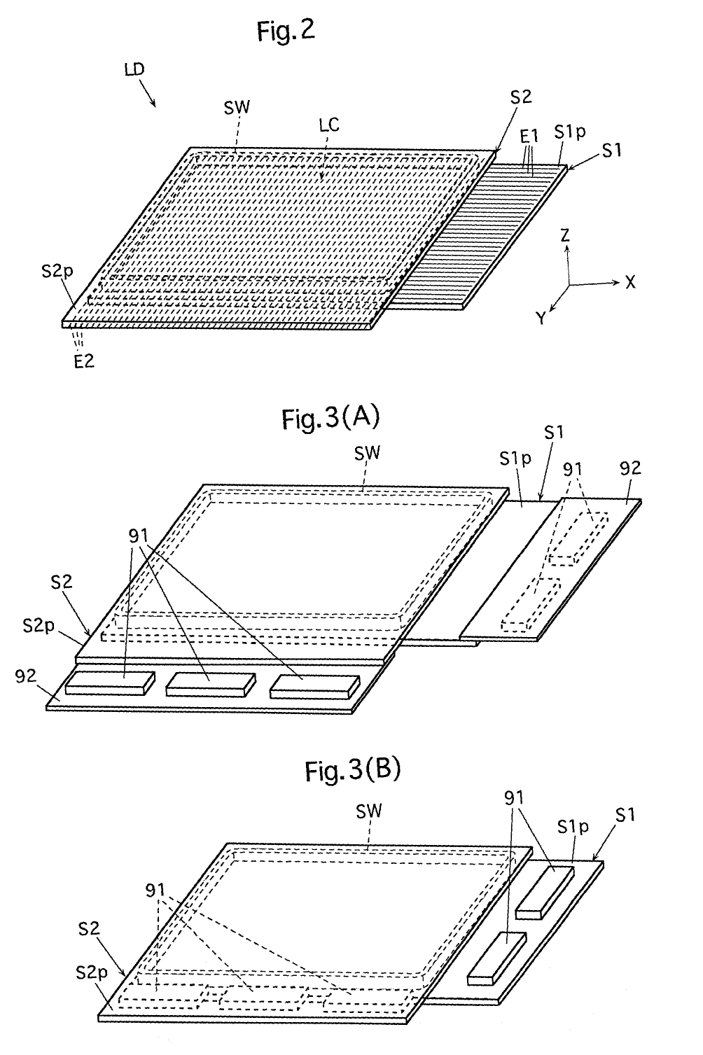

FIG. 1 is a schematic section view showing an example of the liquid crystal display element to be produced. FIG. 2 is a schematic perspective view of the liquid crystal display element of FIG. 1.

The liquid crystal display element LD of FIGS. 1 and 2 is one of the light reflection type.

The liquid crystal display element LD has a pair of first and second substrates S1, S2. A liquid crystal LC is arranged between the substrates S1, S2. A seal wall SW is provided between the substrates to prevent a leakage of liquid crystal from between the substrates. The seal wall SW surrounds the liquid crystal LC between the substrates and adheres to both of the substrates S1, S2.

In this example, the substrates S1, S2 are films formed of polycarbonate, and are both flexible.

Electrodes E1, E2 are formed on the substrates S1, S2, respectively to carry out simple matrix drive. The electrodes E1, E2 are made of ITO in this example. The electrodes E1 formed on the substrate S1 are a plurality of strip electrodes arranged in parallel with each other at a specified pitch. The electrodes E2 formed on the substrate S2 are, like the electrodes E1, a plurality of strip electrodes arranged in parallel with each other at a specified pitch. The strip electrodes E1 extend in an X direction and the strip electrodes E2 extend in a Y direction. The strip electrodes E1 and the strip electrodes E2 are vertical to each other and have a matrix structure.

On the electrodes E1, E2 are formed orientation films AL1, AL2, respectively. The orientation films AL1, AL2 are not shown in FIG. 2.

The liquid crystal LC is a chiral nematic liquid crystal comprising a nematic liquid crystal and a chiral material in this example. The chiral nematic liquid crystal exhibits a cholesteric phase at room temperature and selectively reflects the light of specified wavelength. The liquid crystal LC has selective reflection wavelengths in a green region in this example. The images displayed by the liquid crystal display element LD are observed from the upper side of the substrate S2 in FIG. 1. A light absorbing black layer BK is formed on the outer side of the substrate S1 remote from the observation side.

The liquid crystal display element LD has a plurality of spacers 3 and a plurality of resin structures 4 between the substrates. The spacers 3 and resin structures 4 are not shown in FIG. 2. The spacers 3 are arranged between the substrates S1, S2 to control the gap therebetween or more specifically to control the thickness of liquid crystal LC. The resin structures 4 adhere to both of the substrates S1, S2 and increase the adhesion therebetween and the strength of liquid crystal LD in its entirety.

The substrates S1, S2 partly overlap each other. The substrate S1 has a substrate portion S1p which does not overlap the substrate S2. The electrodes E1 are exposed at the substrate portion S1p. The substrate portion S1p of the substrate S1 at which the electrodes E1 are exposed is arranged in continuous form from the substrate portion at which the substrates S1, S2 overlap each other in a direction in which the electrodes E1 extend. Similarly the substrate S2 has a substrate portion S2p which does not overlap the substrate S1. The electrodes E2 are exposed at the substrate portion S2p. The substrate portion S2p of the substrate S2 at which the electrodes E2 are exposed is arranged in continuous form from the substrate portion at which the substrates S1, S2 overlap each other in a direction in which the electrodes E2 extend.

To each of the substrate portions S1p, S2p at which the electrodes E1, E2 are exposed is connected a substrate 92 on which drive ICs 91 are mounted as shown in FIG. 3(A). Thereby the electrodes E1, E2 are connected to the drive ICs 91. The electrodes E1, E2 are not shown in FIG. 3(A). The substrate 92 on which the drive ICs 91 are mounted assumes the so-called TCP (tape carrier package) form. An electrode pattern is formed on the substrate 92 for connecting the electrodes E1 (E2) on the substrates S1 (S2) to the drive ICs 91. As shown in FIG. 3(B), the drive ICs 91 may be directly mounted on the substrate portions S1p, S2p for connection of the electrodes E1, E2 to the drive ICs 91. In any case, the substrate portions S1p, S2p at which the electrodes E1, E2 are exposed are utilized for connecting the electrodes to the drive ICs 91.

The liquid crystal display element LD can display the desired images in the following way.

The specified voltage corresponding to pixels to be driven is applied between the strip electrodes E1 and the strip electrodes E2 via the drive ICs 91. Thereby the orientation of liquid crystal molecules in the pixels is altered, so that the light-reflected state of the liquid crystal in each pixel is altered. The desired images can be displayed by altering the light-reflected state of the liquid crystal in each pixel according to the desired images.

### §6.

An example of the method for producing the liquid crystal display element LD is elucidated below.

First, the producing method is summarized. A plurality of liquid crystal display elements (16 display elements in this example) are produced from a pair of sheets at one time. The plurality of liquid crystal display elements are formed on a multi-piece production basis from the pair of sheets. For this purpose, a plurality of seal walls are formed from an adhesive material (sealing material) on the sheet. Then the sheets are fixed with the plural seal walls formed of the adhesive material between the sheets. Thereafter the sheets are cut along the predetermined cut lines to give plural liquid crystal display elements. A liquid crystal is supplied onto the sheet, for example, before fixing the sheets. The liquid crystal may be supplied into spaces each surrounded with the substrates and the seal wall after fixing the sheets.

Now, detailed description is given below to the steps in an example of the method for producing liquid crystal display elements LD.

(a) Preliminary Step

First, a pair of first and second sheets SH1, SH2 are provided. In this example, a poly-carbonate film is used as the sheet. The sheets SH1, SH2 having a size required for producing 16 liquid crystal display elements are provided. The first sheet SH1 includes first substrates corresponding to 16 liquid crystal display elements LD to be produced, and similarly the second sheet SH2 includes second substrates corresponding to 16 liquid crystal display elements LD to be produced.

(b) Functional Film-Forming Step

The electrodes E1 being plural strip electrodes and an orientation film AL1 are formed in this order on one surface of the sheet SH1 thus provided. For example, first an electroconductive film (ITO film in this example) is uniformly formed on the sheet SH1. Thereafter the electroconductive film is etched in the specified form by photolithography method or the like, whereby the electrodes E1 being plural strip electrodes can be formed. The orientation film AL1 can be formed using a spin-coating method or the like.

A light absorbing black layer BK is formed on the other side of the sheet SH1. The light absorbing layer BK can be formed by applying a black coating composition to the sheet SH1.

The electrodes E2 and the orientation film AL2 are formed on the sheet SH2 in this order in the same manner as done on the sheet SH1.

(c) Adhesive Material-Supplying Step (Seal Wall-Forming Step)

Subsequently an adhesive material (sealing material) is supplied in a specified configuration onto at least one of the sheets SH1, SH2 to form a plurality of seal walls (16 seal walls in this example).

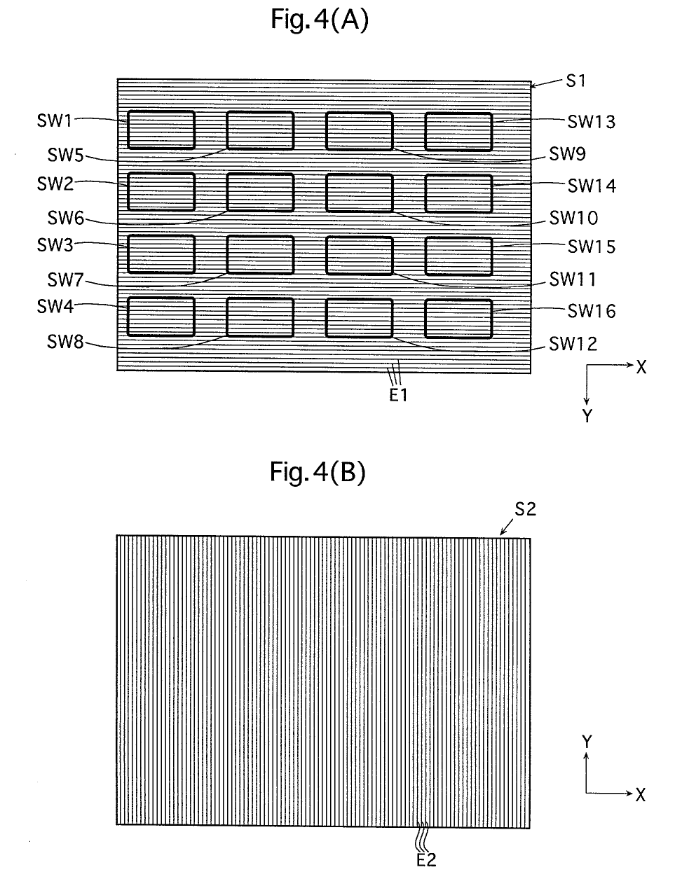

In this example, a seal wall is not formed as shown in FIG. 4(B) on the sheet SH2. As shown in FIG. 4(A), the adhesive material (sealing material) is supplied in a specified configuration onto the sheet SH1 to form 16 seal walls SW1 to SW16. The seal walls SW1 to SW16 correspond to the seal wall SW of the liquid crystal display element of FIG. 1. For convenience sake, 16 liquid crystal display elements including the seal walls SW1 to SW16, respectively may be referred to as liquid crystal display elements LD1 to LD16, respectively. The liquid crystal display elements LD1 to LD16 correspond to the liquid crystal display element LD of FIG. 1.

The seal walls SW1 to SW16 are all in a quadrilateral frame form, and are arranged in 4 columns and 4 rows on the sheet SH1. Any pairs of seal walls adjacent to each other in an X direction in FIG. 4(A) (a direction in which the electrodes E1 extend on the sheet SH1) are spaced away from each other at a specified distance to provide the substrate portions S1p for connection of drive ICs. Similarly any pairs of seal walls adjacent to each other in a Y direction (a direction in which the electrodes E2 extend on the sheet SH2) are spaced away from each other at a specified distance to provide the substrate portions S2p for connection of the drive ICs.

In this example, the adhesive material (sealing material) is supplied in the above-specified configuration by a screen printing method to form seal walls SW1 to SW16.

(d) Spacer-Dispersing Step

Subsequently spacers 3 are dispersed in each region surrounded with respective seal walls SW1 to SW6 at a predetermined density on the sheet SH1. The spacers 3 are dispersed on the sheet SH1 through a mask having openings corresponding to each region surrounded with respective seal walls SW1 to SW16, whereby the spacers 3 can be dispersed only in the above-specified regions on the sheet SH1.

(e) Resin Structure-Forming Step

Subsequently resin structures 4 are formed on at least one of the sheets SH1, SH2.

In this example, the resin structures 4 are formed on the sheet SH2 by a screen printing method. In this example, the resin structures 4 are formed only in regions of the sheet SH2 corresponding to regions inside of the seal walls SW1 to SW16 on the sheet SH1 (in regions surrounded with the seal walls SW1 to SW16).

(f) Liquid Crystal-Supplying Step (Liquid Crystal-Arranging Step)

Subsequently the liquid crystal LC is supplied onto at least one of the two sheets.

In this example, the liquid crystal is disposed in each region surrounded with respective seal walls SW1 to SW16 on the sheet SH1. The liquid crystal is supplied to the above-specified regions on the sheet SH1 by forcing out the liquid crystal from a dispenser (not shown). To each region on the sheet SH1, the liquid crystal is supplied in an amount corresponding to the area of the region surrounded with the seal wall and the specified gap between the substrates.

(g) Sheet-Fixing Step

Subsequently the sheets SH1, SH2 are fixed with the liquid crystal LC and the seal walls formed of the adhesive material between the substrates by being pressed progressively from one end of the sheets to the other end thereof.

The sheets are fixed such that the electrodes E1 on the sheet SH1 and the electrodes E2 on the sheet SH2 cross each other and such that the electrodes E1 and E2 are disposed inside of the sheet (substrate).

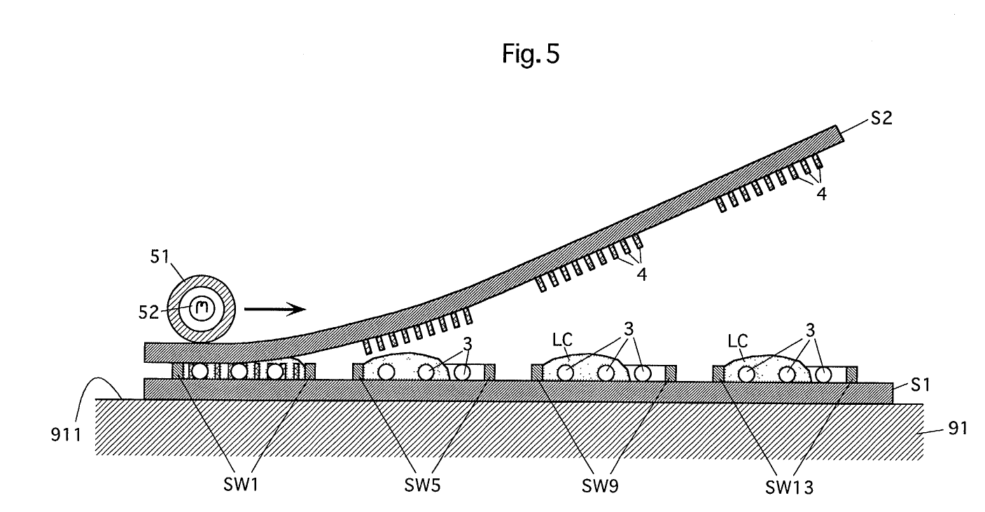

In this example, the sheets SH1, SH2 are fixed in the following manner. Referring to FIG. 5, the sheet-fixing step is described below.

First, the sheet SH1 having the seal walls formed thereon is placed on a flat surface 911 of a table 91. The table 91 has numerous perforations for suction of air (not shown). The sheet SH1 is sucked onto the flat surface 911 of the table 91 by air suction through the perforations. Thereby the sheet SH1 is unmovably held in a specified position on the flat surface 911.

Then, one end of the sheet SH2 is superimposed on one end of the sheet SH1 via the seal walls interposed therebetween. The sheet SH2 is positioned relatively to the sheet SH1 and then the sheets SH1, SH2 are superimposed on each other as above.

Thereafter a roller 51 internally provided with a heater 52 is moved along the table 91, whereby the sheets SH1, SH2 are pressed and heated from one end of the sheets to the other end thereof to fix them with the seal walls SW1 to SW16 and liquid crystal LC interposed therebetween. The resin structures 4 and seal walls SW1 to SW16 formed of an adhesive material adhere to both sheets SH1, SH2 to thereby join them.

At that time, the liquid crystal LC is filled into each region surrounded with respective seal walls SW1 to SW16 between the sheets (substrates of each liquid crystal display element) while being spread with the sheet SH2. Thereby the liquid crystal LC can be disposed between the substrates while forcing out the air bubbles.

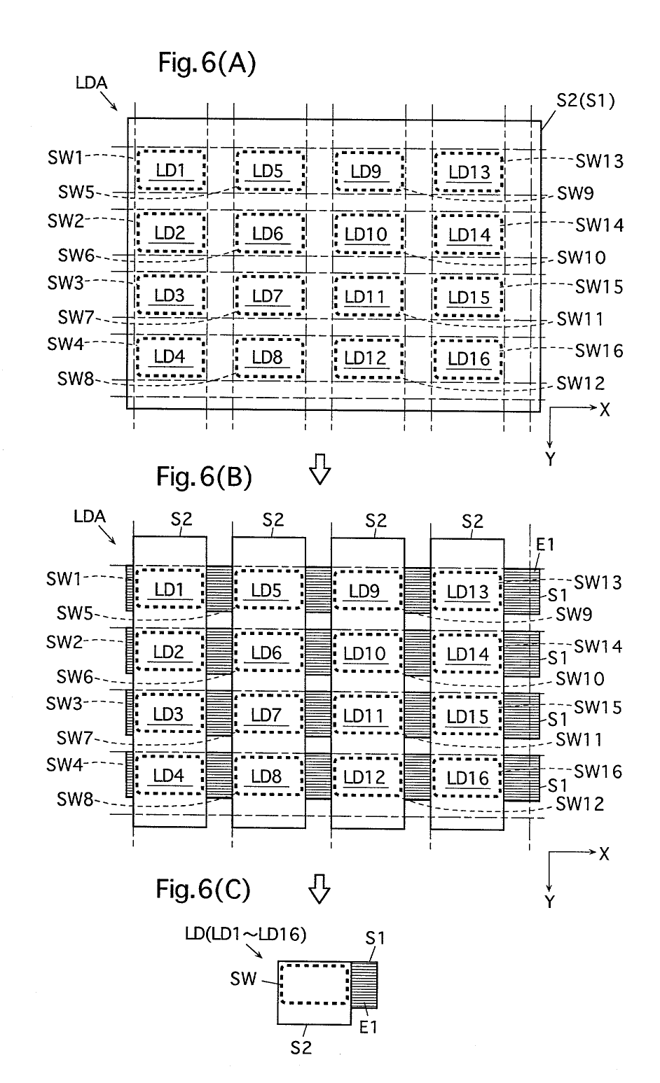

Thereby given is an assembly LDA of 16 liquid crystal display elements in which the 16 liquid crystal display elements LD1 to LD16 are arranged in a continuous form as shown in FIG. 6(A). In the assembly LDA of liquid crystal display elements, the 16 liquid crystal display elements LDA1 to LDA16 are disposed between the pair of sheets SH1, SH2, and the liquid crystal LC is filled in each region surrounded with the seal wall and the sheets (substrates of display element). The spacers 3 and resin structures 4 are disposed between the sheets (substrates). Each of liquid crystal display elements LD1 to LD16 in the assembly thereof at this stage has a structure similar to that of the desired liquid crystal display element LD of FIGS. 1 and 2 although different in that these display elements are continuously arranged with other display elements and that the electrodes are not exposed.

(h) Electrode-Exposing Step

Subsequently each portion of the sheet SH2 overlying the substrate portion S1p of the substrate S1 for connection of each drive IC is removed from the sheet SH2 for the assembly LDA of liquid crystal display elements to expose the electrodes E1 on the substrate portion S1p as shown in FIG. 6(B). Likewise, each portion of the sheet SH1 overlying the substrate portion S2p of the substrate S2 for connection of each drive IC is removed from the sheet SH1 for the assembly LDA of liquid crystal display elements to expose the electrodes E2 on the substrate portion S2p. In this example, the specified portions of the sheets SH1, SH2 can be removed by peeling them.

In this example, to facilitate peeling of predetermined portions from the sheets SH1, SH2, the sheet may be notched (half-cut) along a boundary between the portions to be removed and the remaining portions of the sheet before forming the seal walls in the adhesive material-supplying step.

In this example, the portions of the sheet SH2 (right and left ends of sheet SH2 in FIG. 6(A)) and the portions of the sheet SH1 (upper and lower ends of sheet SH1 in FIG. 6(A)) are also removed, although these portions are not required for the exposure of the electrodes E1 on the substrate portions S1p and the electrodes E2 on the substrate portions S2p. The substrate portions at which the electrodes are exposed are utilized in the inspecting step to be described later. If the inspecting step to be described later is not conducted, the above left, right, upper and lower sheet portions need not be removed.

(i) Cleaning Step

Subsequently the liquid crystal adhering to the sheets SH1, SH2 (substrates S1, S2 of each liquid crystal display element) outside of the seal walls SW1 to SW16 is removed by cleaning for removal. The liquid crystal which overflows to the outside of the seal walls in fixing the sheets as stated above may adhere to the sheet portions outside of the seal walls. Since the electrodes are exposed in the electrode-exposing step, the liquid crystal adhering to between the sheets outside of the seal walls is mostly exposed. The liquid crystal adhering to the sheets outside of the seal walls, e.g. that adhering to the substrate portions of each liquid crystal display element which portions are used for connection of a drive IC to the electrodes, interferes when the drive IC is mounted on the substrate portion. When the drive IC is mounted on the substrate portion with the liquid crystal adhering thereto, the lead of drive IC tends to fail to electrically connect to the electrodes on the substrate.

In this example, the assembly LDA of liquid crystal display elements is immersed in a cleaning liquid to remove the unnecessary liquid crystal by ultrasonic cleaning. After removal of the liquid crystal, the assembly LDA of liquid crystal display elements is withdrawn from the cleaning liquid and dried.

(j) Dividing Step

Subsequently the sheets SH1, SH2 of the assembly LDA of liquid crystal display elements are cut along the cut lines shown with an alternate short and long dash line of FIG. 6(B) to divide the assembly into 16 liquid crystal display elements.

Thereby 16 liquid crystal display elements LD shown in FIGS. 1 and 2 are obtained. Since the electrode-exposing step has been conducted, the electrodes E1, E2 on the substrate portions S1p, S2p of the liquid crystal display element LD are exposed. After completion of the cleaning step, no liquid crystal remains adhering to the regions outside of the seal wall on the substrates S1, S2.

### §7.

The foregoing producing method gives the following advantages because the dividing step is conducted after the electrode-exposing step and the cleaning step.

Even if the electrode-exposing step and the cleaning step are conducted after the dividing step unlike the foregoing producing method, it is possible to produce 16 liquid crystal display elements LD from a pair of sheets SH1, SH2. That is, even when the assembly LDA of liquid crystal display elements is divided into plural liquid crystal display elements LD and thereafter the electrode-exposing step and the cleaning step are conducted on each display element LD, it is possible to give 16 liquid crystal display elements LD in which the electrodes are exposed and the liquid crystal is removed by cleaning. However, in this method, the electrode-exposing step and the cleaning step need to be executed on each liquid crystal display element LD, thus entailing more labor and more time.

In contrast, the cleaning step is conducted on the assembly LDA of liquid crystal display elements before the dividing step in the foregoing producing method. Consequently, the cleaning step can be conducted with less labor and in less time than when the cleaning step is conducted on each liquid crystal display element, so that plural liquid crystal display elements LD can be produced at lower costs.

The assembly LDA of liquid crystal display elements is the unit to be held and transported in conducting the electrode-exposing step and the cleaning step in the foregoing producing method, so that these steps can be done with less labor than when the steps are performed while holding and transporting each liquid crystal display element LD obtained by the division.

In the example described above, all of obtained liquid crystal display elements have the same size. However, according to the producing method described above, it is possible to produce from the pair of sheets SH1, SH2 a plurality of liquid crystal display elements among which one or more liquid crystal display elements have a size different from that of other display elements. In the foregoing producing method, insofar as the sheets SH1, SH2 have a constant size, the same jig(s) and device(s) can be used in holding and transporting the assembly LDA of liquid crystal display elements, whether all of the liquid crystal display elements produced have the same size or not. On the other hand, when the electrode-exposing step and the cleaning step are conducted after the dividing step, holding jig and the like corresponding to the size of the liquid crystal display elements need to be used. Accordingly a fewer jigs can be used in producing liquid crystal display elements according to the foregoing producing method.

Since seal walls SW1 to SW16 are formed as described above in the adhesive material-supplying step, the sheet portions to be removed for exposure of electrodes on the substrates S1, S2 are partly connected to each other. Liquid crystal display elements having the seal walls SW1 to SW16 are hereinafter referred to as liquid crystal display elements LD1 to LD16, respectively, as described above.

The sheet portions to be removed (portions to be removed from the substrates S2 of liquid crystal display elements) are arranged in continuous form in order to expose the electrodes E1 on the substrates S1 of 4 liquid crystal display elements LD1 to LD4 arranged in a Y direction as shown in FIGS. 6(A) and 6(B). Accordingly the predetermined portion including the sheet portions to be removed of the sheet SH2 for the liquid crystal display elements LD1 to LD4 can be removed (peeled) at one time.

The portions to be removed from the sheet SH2 for the liquid crystal display elements LD5 to LD8, LD9 to LD12, and LD13 to LD16 adjacent to each other in the Y direction can be likewise removed at one time.

The portions to be removed from the sheet SH1 for the liquid crystal display elements LD1, LD5, LD9 and LD13 arranged in an X direction can be likewise removed together at one time. The portions to be removed from the sheet SH1 for the other liquid crystal display elements arranged in the X direction can be likewise removed together at one time.

To expose the electrodes on the substrates S1, S2 of liquid crystal display elements LD1 to LD16, the removal of specified portions from the sheets SH1, SH2 is repeated only 8 times according to the foregoing producing method. When the electrode-exposing step is conducted on each liquid crystal display element obtained by the dividing step, the removal of specified portions from the sheets SH1, SH2 is repeated as many as 32 times. Thus, according to the foregoing producing method, the electrode-exposing step can be carried out in less time and with less labor.

From another viewpoint, the seal walls are formed in the adhesive material-supplying step to ensure that the sheet portions (substrate portions) to be removed in the electrode-exposing step for liquid crystal display elements adjacent to each other are arranged in continuous form. That is, the seal walls are formed in the adhesive material-supplying step to ensure that the sheet portions (substrate portions) of the sheet SH2 (substrate S2) to be removed for 4 liquid crystal display elements arranged in a Y direction are arranged in continuous form. In this example, there are 4 groups each composed of 4 liquid crystal display elements adjacent to each other in the Y direction. Thus, the seal walls are formed to ensure that the sheet portions (substrate portions) of the sheet SH2 to be removed for each group of liquid crystal display elements are arranged in continuous form. Also, the seal walls are formed in the adhesive material-supplying step to ensure that the sheet portions (portions of substrate S1) of the sheet SH1 to be removed for 4 liquid crystal display elements arranged in a X direction are arranged in continuous form. In this example, there are 4 groups each composed of 4 liquid crystal display elements adjacent to each other in the X direction. Thus, seal walls are formed to ensure that the sheet portions (portions of substrate S1) of the sheet SH1 to be removed for each group of liquid crystal display elements are arranged in continuous form.

### §8.

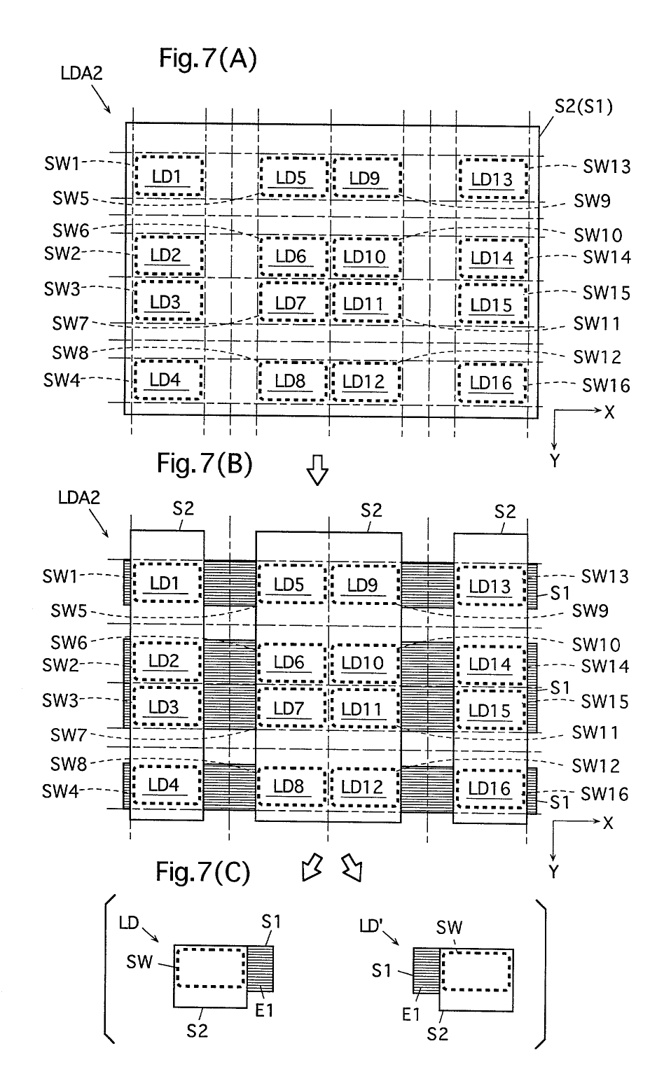

If seal walls are formed as shown in FIG. 7(A), the sheet portions to be removed from the sheets SH1, SH2 can be removed by less repetitions of removal operations in the electrode-exposing step as shown in FIG. 7(B).

In the assembly LDA2 of liquid crystal display elements shown in FIGS. 7(A) and 7(B), the sheet portions (portions of substrate S2) to be removed from the sheet SH2 for 4 liquid crystal display elements LD1 to LD4 adjacent to each other in a Y direction are arranged in continuous form. Further the sheet portions (portions of substrate S2) to be removed from the sheet SH2 for 4 liquid crystal display elements LD5 to LD8 which are adjacent to the liquid crystal display elements LD1 to LD4 in an X direction and which are adjacent to each other in a Y direction are arranged in continuous form. Further the sheet portions to be removed from the sheet SH2 (substrate 2) for liquid crystal display elements LD1 to LD4 are connected to the sheet portions to be removed from the sheet SH2 (substrate S2) for liquid crystal display elements LD5 to LD8. In other words, all of the sheet portions (portions of substrate S2) to be removed from the sheet SH2 for 8 liquid crystal display elements LD1 to LD8 are connected to each other. Consequently the sheet portions (portions of substrate S2) to be removed from the sheet SH2 for 8 liquid crystal display elements LD1 to LD8 can be removed at one time. Similarly the sheet portions (portions of substrate S2) to be removed from the sheet SH2 for liquid crystal display elements LD9 to LD16 can be removed at one time.

The sheet portions (portion of substrate S1) to be removed from the sheet SH1 can be likewise removed by conducting the removal operation twice.

In this case, however, two types of liquid crystal display elements LD and LD′ which are different from each other in the direction of projection of electrodes can be produced after the dividing step, as shown in FIG. 7(C).

### §9.

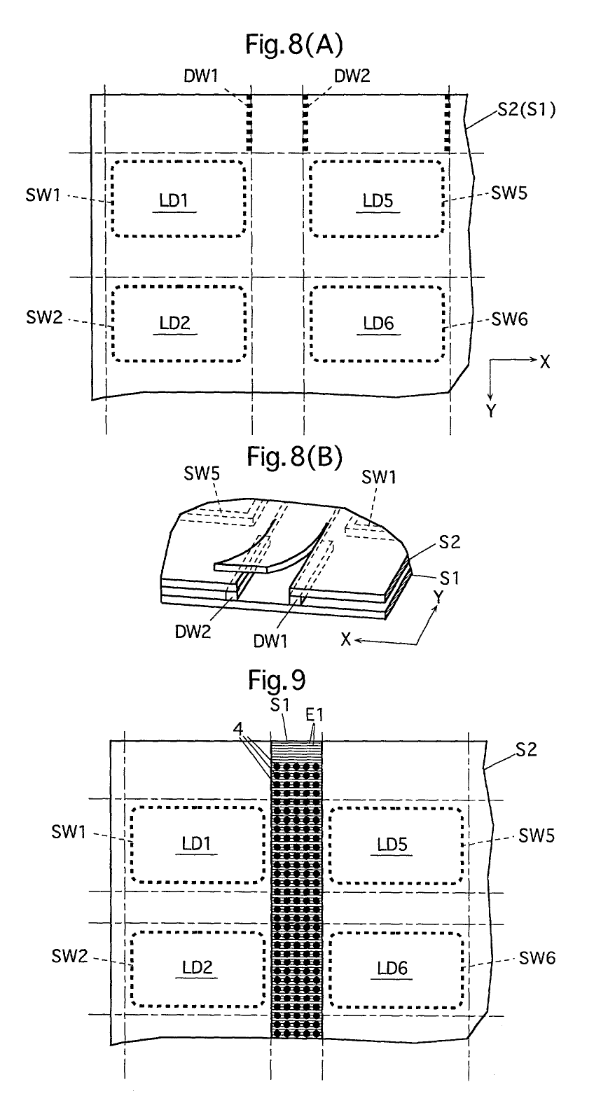

Dummy walls DW1, DW2 as well as the seal walls SW1 to SW16 may be formed from an adhesive material supplied to the substrate in the adhesive material-supplying step as shown in FIGS. 8(A) and 8(B). The assembly LDA of liquid crystal display elements is only partly shown in FIGS. 8(A) and 8(B).

The dummy walls DW1, DW2 are adhered to both of the sheets SH1, SH2 by conducting the fixing step.

The dummy walls DW1, DW2 are formed on a sheet portion along a boundary between the portion of sheet SH2 to be removed in the electrode-exposing step and the remaining portion thereof. The dummy walls DW1, DW2 are formed in a position where the peel of the predetermined portion of sheet SH2 is initiated in the electrode-exposing step.

Other dummy walls are formed in positions like the position of the dummy walls DW1, DW2 although not shown in FIG. 8. These dummy walls are formed in a position which is not included in the substrate of any liquid crystal display element obtained by division of the liquid crystal display element assembly.

The dummy walls DW1, DW2 can suppress exertion of great force on the seal walls SW1, SW5 and the like in peeling the predetermined portion of the sheet SH2 for exposure of the electrodes E1 of liquid crystal display elements LD1, LDA 5 and the like. Therefore, the dummy walls can prevent the separation of seal walls SW1, SW5 and the like from the sheet (substrate of the liquid crystal display element). When the peel of the sheet portion is initiated, a great force is likely to be exerted on the seal walls SW1, SW5 and the like. As described above, the dummy walls SW1, SW2 are formed in a position where the peel of the predetermined portion of sheet SH2 is initiated, thereby preventing the separation of seal walls from the sheet (substrate of the liquid crystal display element).

### §10.

In the resin structure-forming step, resin structures 4 may be formed on a portion of the sheet (substrate) corresponding to a region outside of the seal walls as well as the regions inside of the seal walls. If resin structures 4 are formed on a portion of the sheet corresponding to a region outside of the seal walls, the sheets (substrates) can be fixed together in the fixing step while suppressing deviation of position relation between the two sheets (substrates of a liquid crystal display element), and loosening of sheets.

Even when resin structures 4 are formed on the sheet in the region outside of the seal walls, the resin structures 4 may be formed in a manner not to form them on the sheet SH2 in a position where the peel of the predetermined portion of sheet SH2 is initiated in the electrode-exposing step as shown in FIG. 9. By doing so, the predetermined portion of sheet SH2 can be easily peeled. The same effect can be produced if the resin structures are not formed on a similar sheet portion which is not shown in FIG. 9.

### §11.

When liquid crystal display elements are produced as described above, an inspecting step may be conducted for inspecting the electrodes on the substrates of each liquid crystal display element before the dividing step.

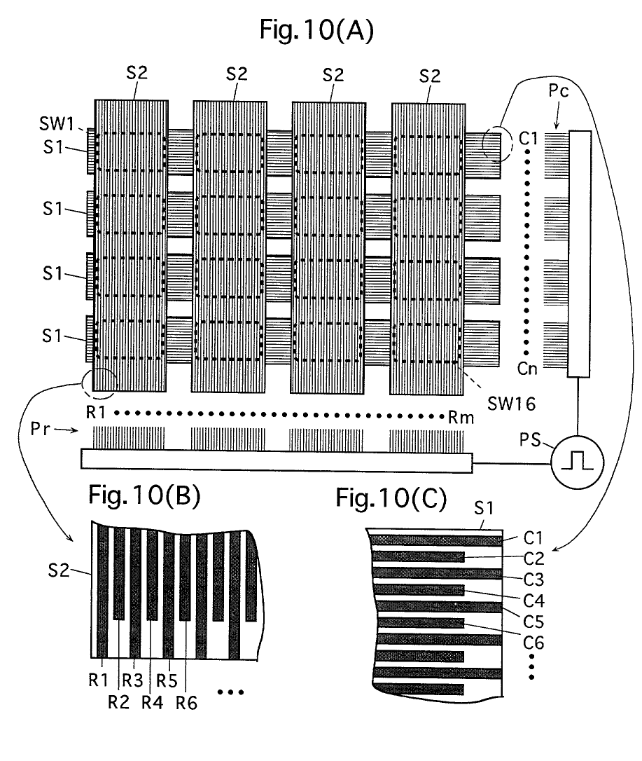

The inspecting step may be conducted, for example, as follows. The following description is given with reference to FIGS. 10(A) to 10(C).

FIG. 10(A) shows the assembly LDA of liquid crystal display elements of FIG. 6(B). The assembly LDA of liquid crystal display elements is one in which the electrode-exposing step and the cleaning step have been conducted. FIG. 10(A) shows the electrodes E2 on the sheet SH2 with a solid line for better understanding.

The electrodes E1 on the sheet SH1 (substrate S1) are column electrodes. The strip electrodes constituting the column electrodes (electrodes E1) are designated C1 to Cn in the order from an upper side to a lower side in FIG. 10(A). The electrodes E2 on the sheet SH2 (substrate S2) are row electrodes. The strip electrodes constituting the row electrodes (electrodes E2) are designated R1 to Rm in the order from a left side to a right side in FIG. 10(B).

On the sheet SH2 (substrate S2), row electrodes designated in odd numbers (R1, R3, R5, etc.) and those designated in even numbers (R2, R4, R6, etc.) have different lengths as shown in FIG. 10(B). The row electrodes designated in odd numbers extend to a lower end of the sheet SH2 (substrate S2), whereas the row electrodes designated in even numbers do not extend to the lower end of the sheet SH2 (substrate S2).

Similarly on the sheet SH1 (substrate S1), column electrodes designated in odd numbers (C1, C3, C5, etc.) and those designated in even numbers (C2, C4, C6, etc.) have different lengths as shown in FIG. 10(C). The column electrodes designated in odd numbers extend to a right end of the sheet SH1 (substrate S1), whereas the column electrodes designated in even numbers do not extend to the right end of the sheet SH1 (substrate S1).

(a) Short-Circuit Inspection

An electrode probe Pc is contacted with the column electrodes designated in odd numbers alone and an electrode probe Pr is contacted with all row electrodes.

The electrode probe Pc has electrodes in the same number as the column electrodes. Likewise the electrode probe Pr has electrodes in the same number as the row electrodes.

The electrode probe Pc can be contacted with only column electrodes designated in odd numbers by bringing the electrode probe Pc into contact with only the column electrodes in a position where the column electrodes designated in even numbers is not formed. The electrode probe Pr can be contacted with all row electrodes by bringing the electrode probe Pr into contact with a portion at which the row electrodes designated in even numbers and designated in odd numbers are formed.

In this way, the probes Pc and Pr are contacted with the column electrodes and row electrodes, and thereafter a power source PS applies the predetermined voltage via the probes to the electrodes so that the liquid crystal of pixels to be driven is brought into a state of selective reflection. When a short circuit does not occur between the neighboring column electrodes, only the liquid crystal of pixels corresponding to column electrodes designated in odd numbers in each liquid crystal display element is brought into a state of light reflection and uniform image display can be achieved. If a short circuit occurs between the adjoining column electrodes, a liquid crystal of pixels corresponding to the column electrode(s) designated in even number(s) which is (are) short-circuited with the column electrode(s) designated in odd number(s) are brought into light reflection, which indicates that a short circuit has occurred. Thereby the occurrence of short circuit in column electrodes can be found and the short-circuited column electrodes can be identified.

When column electrodes are suffering a short circuit, a check is carried out as described below to find out at which position the column electrodes are short-circuited.

When an electrical resistance between the short-circuited electrodes is measured, the position of short circuit can be presumed from the electrical resistance. Accordingly it is seen which liquid crystal display element is suffering a short circuit.

The inspection for short circuit of row electrodes is feasible in the same manner.

(b) Electrode-Breakage Inspection

The probe Pc is contacted with all column electrodes and the probe Pr is contacted with all row electrodes. Then the power source PS applies the predetermined voltage between respective column electrodes and row electrodes. The liquid crystal of all pixels is brought into a state of selective reflection. If there occur breakage in any of column electrodes and row electrodes, pixels are found which are not brought into a state of reflection. This indicates column electrode(s) and/or row electrode(s) is (are) broken.

When the electrodes are checked in this manner before the dividing step, the electrodes in a plurality (16) of liquid crystal display elements can be examined collectively. This reduces the labor for inspection and the time taken therefor.

When the sheets (substrates) are cut along the specified cut lines to give plural liquid crystal display elements, a sheet portion (substrate portion) having an electrode portions with which the probe has been contacted should be cut off. Thereby even if the electrode portions with which the probe has been contacted are damaged, development of cracks is prevented, which otherwise would lead to damage of electrodes.

After the division, a liquid crystal display element having defective electrode(s) is not subjected to the next step of, for example, mounting a drive IC, so that a futile step need not be conducted.

### §12.

The methods of fixing the sheets in the fixing step are not limited to the method shown in FIG. 5.

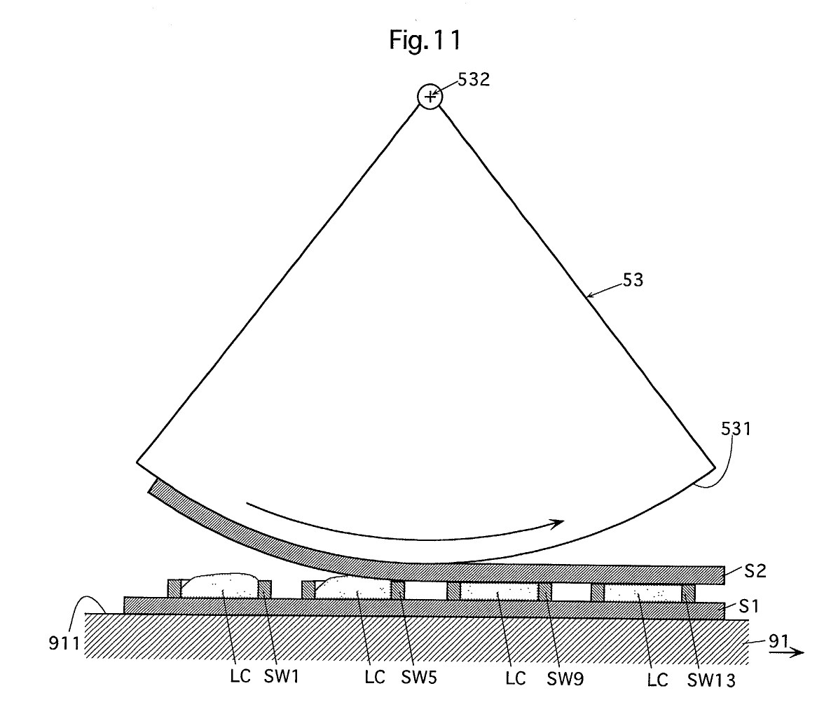

(a) For example, the sheets SH1, SH2 may be fixed together as described below using a pressing member 53 shown in FIG. 11 which is in a shape of sector in section in place of the pressing roller 51 of FIG. 5.

The sheet SH1 having seal walls and the like is held by a flat table 91. The sheet SH2 is held by suction on a circumferential surface 531 of the pressing member 53.

The pressing member 53 is turned in a counterclockwise direction in the drawing about a fulcrum 532. The table 91 is moved rightwardly in the drawing synchronously with the rotation of the pressing member 53, whereby the sheets SH1, SH2 are fixed while being pressed progressively from one end (right end in the drawing) of the sheets to the other end thereof.

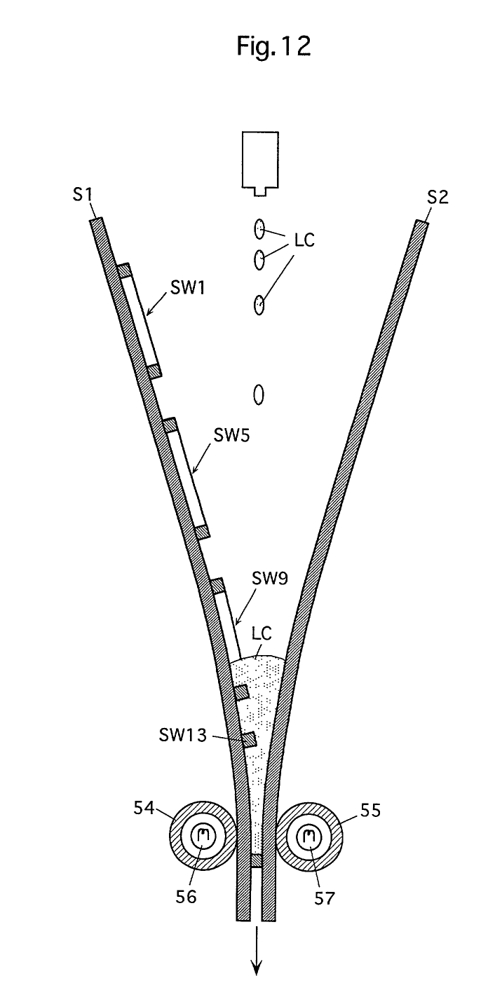

(b) The sheets SH1, SH2 may be passed as shown in FIG. 12 through a pair of opposed pressing rollers 54, 55 from an upper side to a lower side while being progressively superimposed over each other to fix the sheets. The pressing rollers 54, 55 are internally provided with heaters 56, 57, respectively. The sheets SH1, SH2 are fixed while being pressed and heated.

In this case, the liquid crystal LC may be supplied onto the sheets SH1, SH2 from between the sheets SH1, SH2 during the fixing operation. Spacers may be dispersed into the liquid crystal LC to be supplied onto the sheets SH1, SH2 instead of dispersing the spacers on the sheet (substrate).

### §13.

In the foregoing description, the liquid crystal is charged into spaces each surrounded with the substrates and the seal wall by supplying the liquid crystal onto the sheet(s) before and/or during the fixing operation. The liquid crystal may be injected into the space after fixing the sheets.

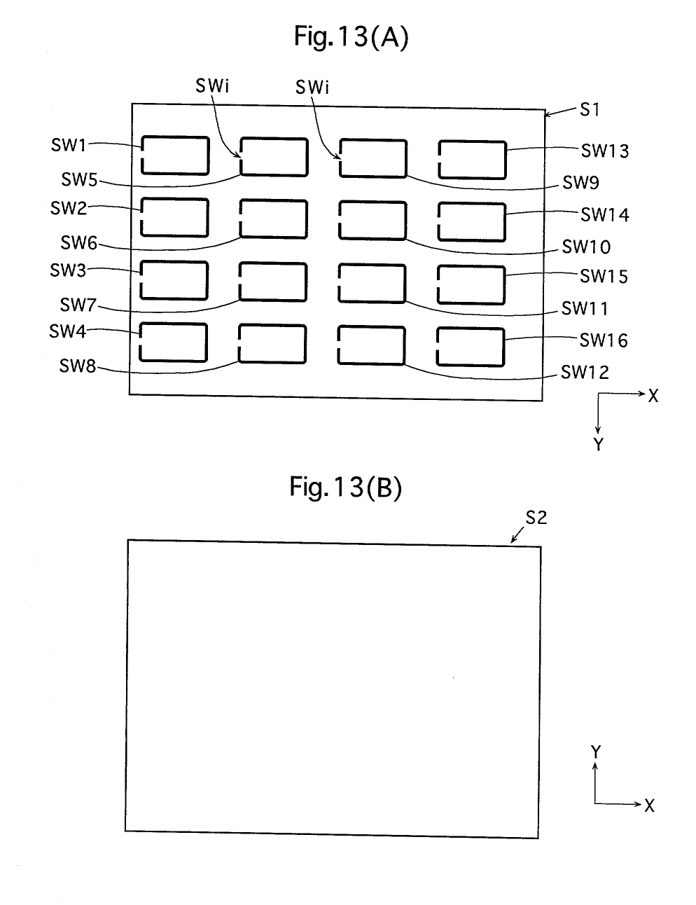

When the liquid crystal is injected into the space surrounded with the substrates and the seal wall after fixing the sheets, the seal wall formed on the sheet in the adhesive material-supplying step may be provided with, for example, an inlet port SWi for entry of the liquid crystal as shown in FIG. 13.

In this event, the sheet-fixing step gives vacant liquid crystal display elements (empty cells) in which the liquid crystal is not charged in each space surrounded with the substrates and the seal wall. More specifically, there is obtained an assembly of vacant liquid crystal display elements (empty cells). Even when the assembly of vacant liquid crystal display elements is produced, the sheets can be fixed, e.g. by the methods of fixing sheets described above.

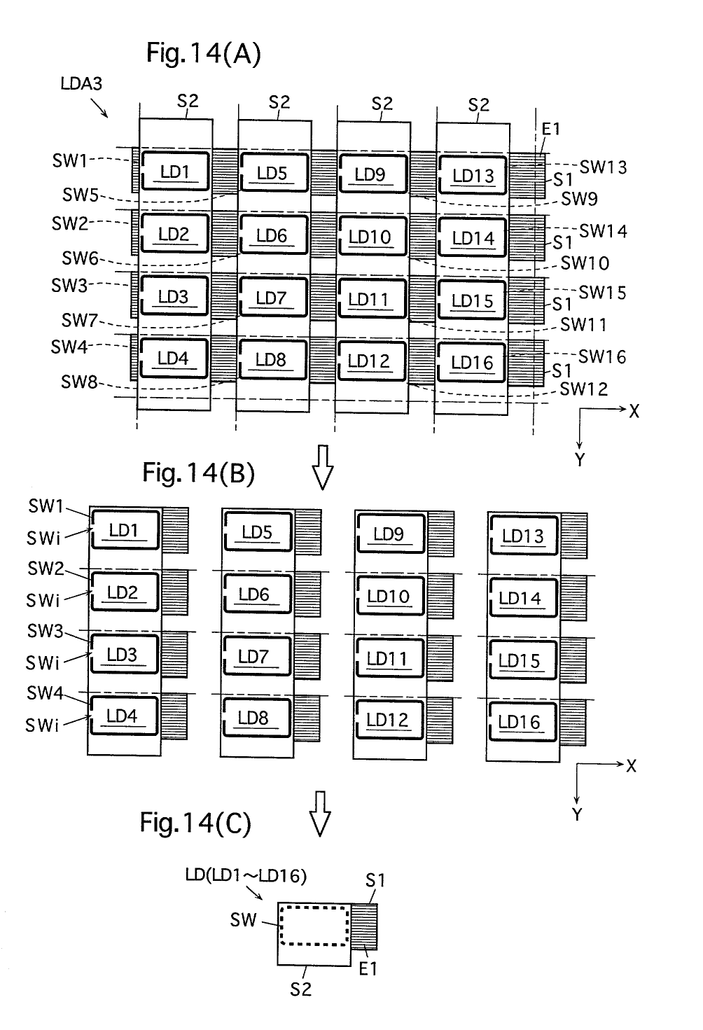

Even when the assembly of vacant liquid crystal display elements is produced, the electrode-exposing step can be performed with less labor since the electrode-exposing step is performed before the dividing step as shown in FIG. 14(A). FIG. 14(A) shows the seal walls with a solid line for better understanding of the inlet port for entry of liquid crystal.

The above-described various procedures taken in the steps when liquid crystal display elements are produced by performing the liquid crystal-supplying step can be employed when liquid crystal display elements are produced by giving vacant liquid crystal display elements. The same effects can be obtained.

In the case where vacant liquid crystal display elements are produced, the liquid crystal is injected through the inlet port for entry of liquid crystal into the space surrounded with the substrates and the seal wall, for example, by vacuum injection method. After injection of the liquid crystal, the inlet port for entry of liquid crystal may be closed with a sealing material.

The liquid crystal-injecting step may be conducted before or after the dividing step, and before or after the electrode-exposing step. When the cleaning step is conducted, this step may be performed before or after the dividing step. If the liquid crystal-injecting step and the cleaning step are carried out before the dividing step, these steps can be executed with less labor.

When an assembly LDA3 which is a collection of 16 vacant liquid crystal display elements shown in FIG. 14(A) is produced, the liquid crystal-injecting step may be done after pre-division (pre-cut) of the assembly LDA3 as shown in FIG. 14(B). If the assembly LDA3 is pre-divided as shown in FIG. 14(B), 4 assemblies of vacant liquid crystal display elements (4 collections thereof) are given. Each assembly has 4 seal walls aligned in a row. In the assembly LDA3, inlet ports SWi for entry of liquid crystal formed in the seal walls are aligned on one straight line. In view of this arrangement, the liquid crystal can be easily injected into each space surrounded with the seal wall and the substrates. After the injection of liquid crystal, for example, the four assemblies are cleaned and divided, giving 16 liquid crystal display elements.

The liquid crystal-injecting step may be conducted on each liquid crystal display element after dividing the assembly LDA3 of vacant liquid crystal display elements into 16 display elements.

As stated above, even when the liquid crystal is supplied between the substrates by injection of liquid crystal after the fixing step, the inspecting step would be conducted with less labor if performed before the dividing step.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method of producing a plurality of liquid crystal display elements, each of the liquid crystal display elements including a first substrate, a second substrate, a liquid crystal and a seal wall, the first substrate being provided with a plurality of first electrodes formed thereon, the second substrate being provided with a plurality of second electrodes formed thereon, the liquid crystal being arranged between the first and second substrates, the seal wall being arranged between the first and second substrates, surrounding the liquid crystal and being adhered to both of the first and second substrates, the method comprising:
(a) a display elements group producing step of producing a display elements group through first and second steps,
the first step being performed to form the seal walls for the plurality of the liquid crystal display elements on at least one of first and second sheets,
the first sheet being provided with the first electrodes for the plurality of the liquid crystal display elements, and including a plurality of portions that are to be the first substrates for the plurality of the liquid crystal display elements,
the second sheet being provided with the second electrodes for the plurality of the liquid crystal display elements, and including a plurality of portions that are to be the second substrates for the plurality of the liquid crystal display elements,
the second step being performed to adhere the first and second sheets together with the seal walls therebetween, and to expose first and second terminal portions of each of the plurality of the liquid crystal display elements by removing at least one predetermined removal portion from at least one of the first and second sheets; and
(b) a dividing step of dividing the display elements group into the plurality of the liquid crystal display elements or into the plurality of empty-liquid crystal display elements for the plurality of the liquid crystal display elements, by cutting at least one of the first and second sheets of the display elements group in at least one predetermined position, the dividing step being performed after the display elements group producing step.

2. A method according to claim 1, wherein the first and second sheets are adhered together with the liquid crystals for the plurality of the liquid crystal display elements therebetween in the second step.

3. A method according to claim 1, wherein the liquid crystal is filled into each of the liquid crystal display elements after the second step.

4. A method according to claim 1, further comprising a cleaning step for removing the liquid crystal at an outside of the seal wall, the cleaning step being performed after the display elements group producing step.

5. A method according to claim 4, wherein the cleaning step is performed before the dividing step.

6. A method according to claim 1, wherein the first and second sheets are adhered together while applying a heat in the second step.

7. A method according to claim 1, wherein the seal walls for the plurality of the liquid crystal display elements are formed to be aligned in a predetermined direction in the first step.

8. A method according to claim 7, wherein the predetermined removal portion is located between the two seal walls neighboring to each other.

9. A method according to claim 1, wherein each of the first and second sheets has said at least one predetermined removal portion.

10. A method according to claim 9, wherein the seal walls for the plurality of the liquid crystal display elements are formed in a matrix form in the first step.

11. A method according to claim 1, wherein at least one dummy wall is formed, in addition to the seal walls, along said at least one predetermined removal portion in the first step, and said at least one dummy wall is adhered to both of the first and second sheets in the second step.

12. A method according to claim 11, wherein said at least one dummy wall is formed at an end portion of at least one of the first and second sheets.

13. A method according to claim 11, wherein said at least one dummy wall is formed in a position which is not included in any one of the liquid crystal display elements after the dividing step.

14. A method according to claim 1, further comprising a resin structure forming step of forming at least one resin structure on at least one of the first and second sheets, the resin structure forming step being performed before the second step.

15. A method according to claim 14, wherein said at least one resin structure is formed on each of regions inside and outside of the seal walls in the resin structure forming step, and the resin structure is not formed on a portion, from which the removing operation is started, of said at least one predetermined removal portion.

16. A method according to claim 1, further comprising an inspecting step of inspecting each of the liquid crystal display elements in the display elements group, the inspecting step being performed before the dividing step.
